(19) United States
(12) Patent Application Publication
(10) Pub. No.: US 2026/0323612 A1
(43) Pub. Date: Oct. 15, 2026

(54) METHOD AND APPARATUS FOR RECEIVING PPDU IN WIRELESS LAN SYSTEM

(71) Applicant: LG Electronics Inc., Seoul (KR)

(72) Inventors: Dongguk LIM, Seoul (KR); Jinyoung CHUN, Seoul (KR); Jinsoo CHOI, Seoul (KR); Eunsung PARK, Seoul (KR)

(21) Appl. No.: 19/476,395

(22) PCT Filed: Apr. 11, 2024
(86) PCT No.: PCT/KR2024/004803

§ 371 Date: Oct. 17, 2025

(30) Foreign Application Priority Data
May 9, 2023 (KR) 10-2023-0059953

(51) Int. Cl. H04W 72/0453; H04L 1/00; H04W 84/12

(52) U.S. Cl. CPC H04W 72/0453; H04L 1/0003; H04W 84/12

(57) ABSTRACT

A method and an apparatus for receiving a PPDU in a wireless LAN system are proposed. Specifically, a receiving STA receives a PPDU from a transmitting STA and decodes the PPDU. The PPDU comprises a first and a second signal field and a data field. The first signal field comprises information indicating that the data field is transmitted via an MRU configured by a combination of non-continuous first and second RUs. The second signal field comprises a common field and a user-specific field. The common field comprises RU assignment information for a combination of the non-continuous first and second RUs. The user-specific field comprises a single unified user field for the first and second RUs.

### TECHNICAL FIELD

This specification relates to a technique for receiving a PPDU in a wireless LAN system, and more specifically, to a method and device for configuring a signal field for transmitting data by allocating an MRU composed of two non-continuous RUs and applying different transmission parameters, for example, MCS and Nss, to each RU.

### BACKGROUND ART

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### DISCLOSURE

### Technical Problem

This specification proposes a method and device for receiving a PPDU in a wireless LAN system.

### Technical Solution

An example of this specification proposes a method for receiving a PPDU.

This embodiment may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

This embodiment is performed at a receiving STA, and the receiving STA may correspond to at least one station (STA). The transmitting STA may correspond to an access point (AP).

This embodiment proposes a method for allocating an MRU composed of two non-continuous RUs and configuring a signal field for transmitting data by applying different transmission parameters, e.g., MCS and Nss, to each RU. In particular, the present embodiment proposes a method for allocating two non-continuous RUs within an MRU through a new RU allocation subfield in the signal field and configuring one unified user field for each of the two RUs to indicate the MCS and Nss applied to each RU.

A receiving station (STA) receives a Physical layer protocol data unit (PPDU) from a transmitting STA.

The receiving STA decodes the PPDU.

The PPDU includes first and second signal fields and a data field.

The first signal field includes information that the data field is transmitted through a Multiple Resource Unit (MRU) composed of a combination of non-continuous first and second Resource Units (RUS).

The second signal field includes a common field and a user-specific field. The common field includes RU allocation information for the combination of the non-continuous first and second RUs. The RU allocation information is newly defined information based on a value of a Disregard bit (or reserved bit) of the RU allocation subfield, and a detailed description will be provided later.

The user-specific field includes one user field integrated for the first and second RUs. The one user field may be configured to include different MCS and Nss information for each RU. For example, the one user field includes information on a first Modulation and Coding Scheme (MCS) applied to the first RU and information on a second MCS applied to the second RU.

Additionally, the one user field may further include information on a first Number of spatial streams (Nss) applied to the first RU and information on a second Nss applied to the second RU.

Based on a channel status of the first and second RUs, the first RU may be transmitted based on/by applying the first MCS and the first Nss, and the second RU may be transmitted based on/by applying the second MCS and the second Nss. A sum of the first and second Nss may not exceed 8.

In the past, there was a problem that the overall transmission efficiency and throughput were reduced when transmitting a signal by commonly applying transmission parameters to MRUs even when the channel condition of a specific channel within an MRU was poor due to OBSS, fading, etc. Therefore, this embodiment proposes a method of transmitting a signal by applying different transmission parameters to each RU by considering the channel status of an MRU composed of non-continuous RUs. That is, this embodiment proposes a method of configuring a newly defined RU allocation subfield to apply different MCS and Nss to each RU within the MRU and a single integrated user field for non-continuous RUs.

### Advantageous Effects

According to the embodiment proposed in this specification, by transmitting a signal by applying transmission parameters suitable for the channel status to each RU within an MRU, there is an effect of improving the overall transmission efficiency and throughput compared to applying common (or unified) transmission parameters to the MRU.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 shows an example of a multi-link (ML),

FIG. 5 shows an example of a physical protocol data unit or physical layer (PHY) protocol data unit (PPDU) transmitted/received by an STA of the present disclosure.

FIG. 6 is a diagram illustrating the layout of resource units (RUs) used for a 20 MHz PPDU.

FIG. 7 is a diagram illustrating the layout of resource units (RUs) used for 40 MHz PPDU.

FIG. 8 is a diagram illustrating the layout of resource units (RUs) used for an 80 MHz PPDU.

FIG. 9 shows an operation related to UL-MU.

FIG. 10 illustrates an example of channels used/supported/defined within the 2.4 GHZ band.

FIG. 11 illustrates an example of channels used/supported/defined within the 5 GHz band

FIG. 12 illustrates an example of channels used/supported/defined within the 6 GHz band

FIG. 13 shows an example of a header of a MAC frame.

FIG. 14 illustrates an example of a modified transmission device and/or receiving device of the present specification.

FIG. 15 illustrates an example of an EHT-SIG content channel for 320 MHz OFDMA transmission.

FIG. 16 illustrates an example of an EHT-SIG content channel for EHT SU transmission,

FIG. 17 illustrates an example of an RU Allocation subfield defined in an 802.11be WLAN system.

FIG. 18 illustrates an example of an RU Allocation subfield defined in an 802.11be WLAN system.

FIG. 19 illustrates an example of an RU Allocation subfield defined in an 802.11be WLAN system.

FIG. 20 illustrates an example of an RU Allocation subfield defined in an 802.11be WLAN system.

FIG. 21 illustrates an example of an RU Allocation subfield defined in an 802.11be WLAN system.

FIG. 22 illustrates an example of an RU Allocation subfield defined in an 802.11be WLAN system.

FIG. 23 illustrates an example of the RU Allocation subfield defined in an 802.11be WLAN system.

FIG. 24 illustrates an example of the RU Allocation subfield defined in an 802.11be WLAN system.

FIG. 25 illustrates an example of the RU Allocation subfield defined in an 802.11be WLAN system.

FIG. 26 illustrates the arrangement of 484+242-tone MRUs in an 80 MHz bandwidth.

FIG. 27 illustrates the arrangement of 996+484-tone MRUs in a 160 MHz bandwidth.

FIG. 28 illustrates the arrangement of 996+484+242-tone MRUs in a 160 MHz bandwidth.

FIG. 29 illustrates the arrangement of 2×996+484-tone MRUs in a 320 MHz bandwidth.

FIG. 30 illustrates the layout of 3×996-tone MRUs in a 320 MHz bandwidth.

FIG. 31 illustrates the layout of 3×996+484-tone MRUs in a 320 MHz bandwidth.

FIG. 32 illustrates an example of an NDP Announcement frame format.

FIG. 33 illustrates a procedure for an STA to select an optimal subchannel or RU.

FIG. 34 is a flowchart illustrating the operation of a transmitting device according to the present embodiment.

FIG. 35 is a flowchart illustrating the operation of a receiving device according to the present embodiment.

FIG. 36 is a flowchart illustrating a procedure for transmitting a PPDU according to the present embodiment.

FIG. 37 is a flowchart illustrating a procedure for receiving a PPDU according to the present embodiment.

### MODE FOR INVENTION

In the present disclosure, “A or B” may mean “only A”, “only B” or “both A and B”. In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, a parenthesis used in the present disclosure may mean “for example”. Specifically, when indicated as “control information (UHR-signal field)”, it may mean that “UHR-signal field” is proposed as an example of the “control information”. In other words, the “control information” of the present disclosure is not limited to “UHR-signal field”, and “UHR-signal field” may be proposed as an example of the “control information”. In addition, when indicated as “control information (i.e., UHR-signal field)”, it may also mean that “UHR-signal field” is proposed as an example of the “control information”.

Also, “a/an” as used in this disclosure can mean “at least one” or “one or more.” Also, a term ending with “(s)” can mean “at least one” or “one or more.”

Also, the expressions “based on” or “on the basis of” or “according to” as used in this disclosure mean “based at least in part on,” and do not mean “based sonly on.”

Technical features described individually in one figure in the present disclosure may be individually implemented, or may be simultaneously implemented.

The following example of the present disclosure may be applied to various wireless communication systems. For example, the following example of the present disclosure may be applied to a wireless local area network (WLAN) system. For example, the present disclosure may be applied to the IEEE 802.11a/g/n/ac/ax/be/bn standard. In addition, an example of the present disclosure can also be applied to a next-generation wireless LAN standard that enhances the Ultra High Reliability (UHR) standard or IEEE 802.11bn. In addition, the example of the present disclosure may also be applied to a new WLAN standard enhanced from the EHT standard or the IEEE 802.11be standard. In addition, the example of the present disclosure may be applied to a mobile communication system. For example, it may be applied to a mobile communication system based on long term evolution (LTE) depending on a 3rd generation partnership project (3GPP) standard and based on evolution of the LTE. In addition, the example of the present disclosure may be applied to a communication system of a 5G NR standard based on the 3GPP standard.

Hereinafter, in order to describe a technical feature of the present disclosure, a technical feature applicable to the present disclosure will be described.

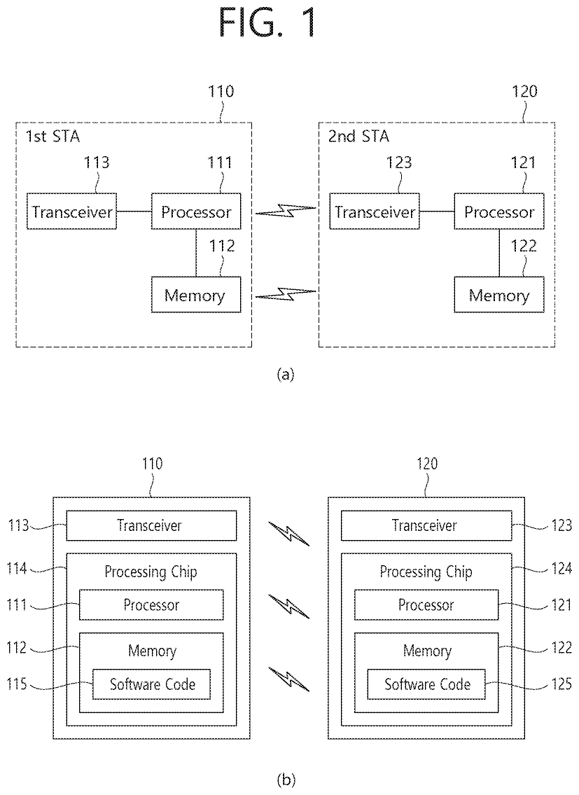

FIG. 1 shows an example of a transmitting apparatus and/or receiving apparatus of the present disclosure.

In the example of FIG. 1, various technical features described below may be performed. FIG. 1 relates to at least one station (STA). For example, STAs 110 and 120 of the present disclosure may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present disclosure may also be called in various terms such as a network, a base station, a node-B, an access point (AP), a repeater, a router, a relay, or the like. The STAs 110 and 120 of the present disclosure may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present disclosure may serve as the AP and/or the non-AP. In the present disclosure, the AP may be indicated as an AP STA.

The STAs 110 and 120 of the present disclosure may support various communication standards together in addition to the IEEE 802.11 standard. For example, a communication standard (e.g., LTE, LTE-A, 5G NR standard) or the like based on the 3GPP standard may be supported. In addition, the STA of the present disclosure may be implemented as various devices such as a mobile phone, a vehicle, a personal computer, or the like. In addition, the STA of the present disclosure may support communication for various communication services such as voice calls, video calls, data communication, and self-driving (autonomous-driving), or the like.

The STAs 110 and 120 of the present disclosure may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the disclosure described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the disclosure described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the disclosure described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1 an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present disclosure will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present disclosure may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present disclosure, an uplink may imply a link for communication from a non-AP STA to an AP STA, and an uplink PPDU/packet/signal or the like may be transmitted through the uplink. In addition, in the present disclosure, a downlink may imply a link for communication from the AP STA to the non-AP STA, and a downlink PPDU/packet/signal or the like may be transmitted through the downlink.

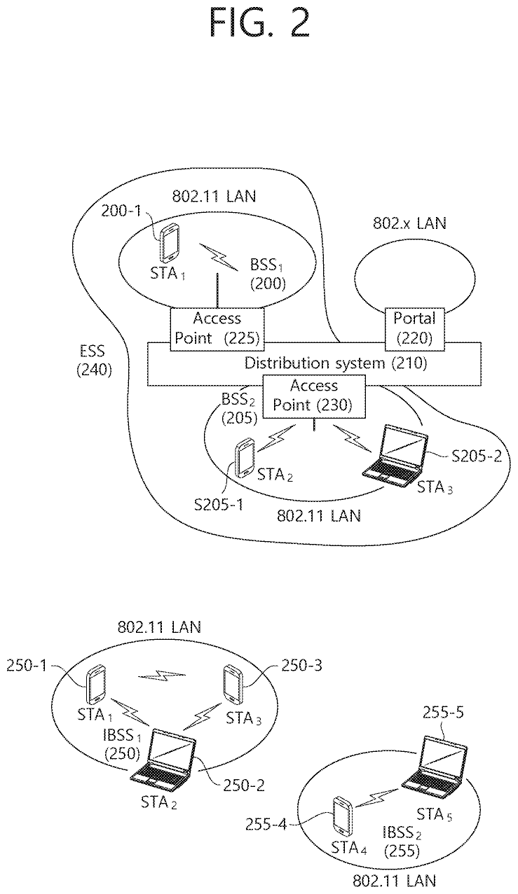

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, an AP 225, 230 providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

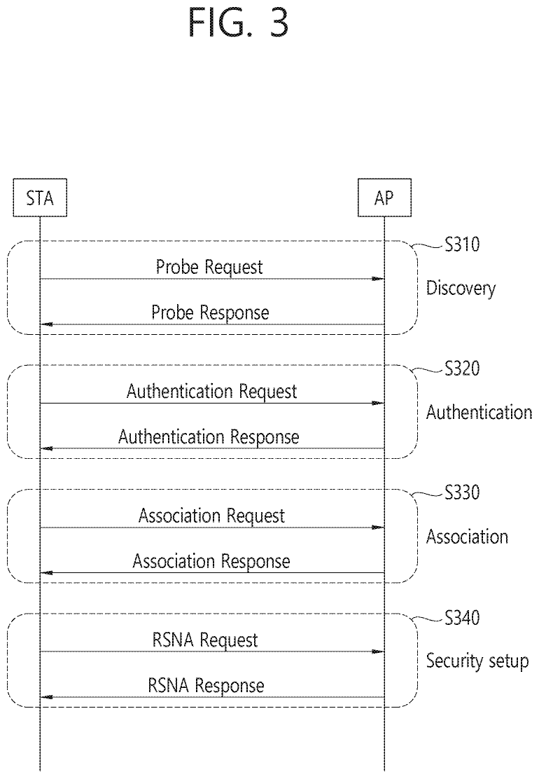

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

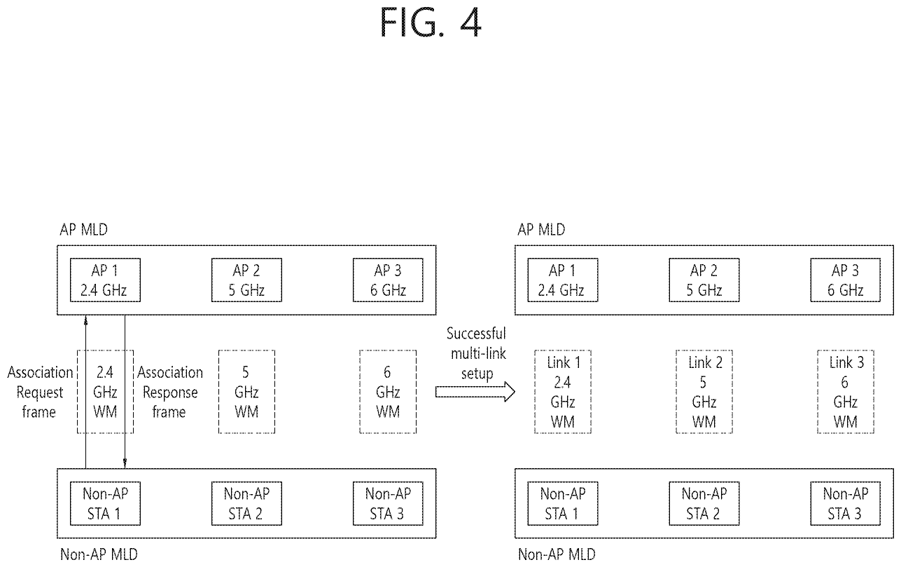

FIG. 4 shows an example of a multi-link (ML).

As illustrated in FIG. 4, multiple multi-link devices (MLDs) can perform communication via a remote link. The MLD can be classified into an AP MLD including multiple AP STAs and a non-AP MLD including multiple non-AP STAs. That is, the AP MLD can include affiliated APs (i.e., AP STAs), and the non-AP MLD can include affiliated STAs (i.e., non-AP STAs, or user-STAs).

The multi-link can include a first link and a second link, and different channels/subchannels/frequency resources can be allocated to the first and second links. The first and second multi-links can be identified through a link ID of 4 bits (or other n bits). The first and second links may be configured in the same 2.4 GHz, 5 GHZ, or 6 GHz band. Alternatively, the first link and the second link may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link in which AP1 and non-AP1 operate may be defined as a channel/subchannel/frequency resource within the 2.4 GHz band. In addition, in the example of FIG. 4, the second link in which AP2 and non-AP2 operate may be defined as a channel/subchannel/frequency resource within the 5 GHz band. In addition, in the example of FIG. 4, the third link where AP3 and non-AP3 operate can be defined as a channel/subchannel/frequency resource within the 6 GHz band.

In the example of FIG. 4, AP1 can start a multi-link setup procedure (ML setup procedure) by transmitting an association request frame to non-AP STA1. In the example of FIG. 4, non-AP STA1 can transmit an association response frame in response to the association request frame. Each AP (e.g., AP1/2/3) illustrated in FIG. 4 may be identical to the AP illustrated in FIG. 1 and/or FIG. 2, and each non-AP (e.g., non-AP1/2/3) illustrated in FIG. 4 may be identical to the STA (i.e., user-STA or non-AP STA) illustrated in FIG. 1 and/or FIG. 2.

The specific features of the present disclosure are not limited to the specific features of FIG. 4. That is, the number of links can be defined in various ways, and multiple links can be defined in various ways within at least one band.

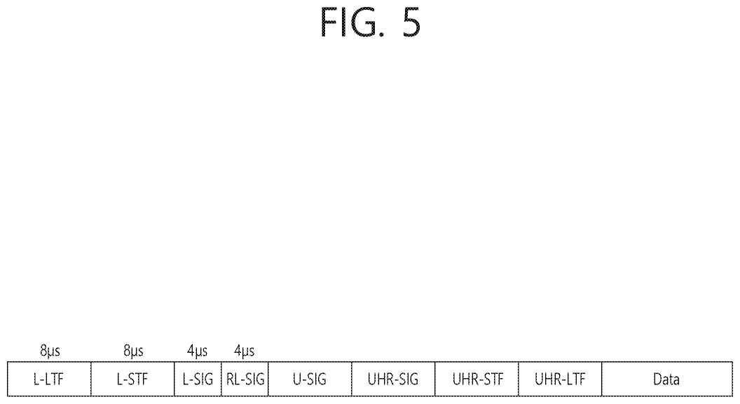

FIG. 5 shows an example of a physical protocol data unit or physical layer (PHY) protocol data unit (PPDU) transmitted/received by an STA of the present disclosure.

An STA (e.g., an AP STA, a non-AP STA, an AP MLD, a non-AP MLD) of the present disclosure can transmit and/or receive a PPDU of FIG. 5. The PPDU described in the present disclosure can have, for example, a structure of FIG. 5. In addition, the PPDU described in the present disclosure can be called by various names such as a transmission PPDU, a reception PPDU, a first type or an N^{th} type PPDU, etc. The PPDU described in the present disclosure can be used in a WLAN system defined according to IEEE 802.11bn and/or a next-generation WLAN system that improves IEEE 802.11bn.

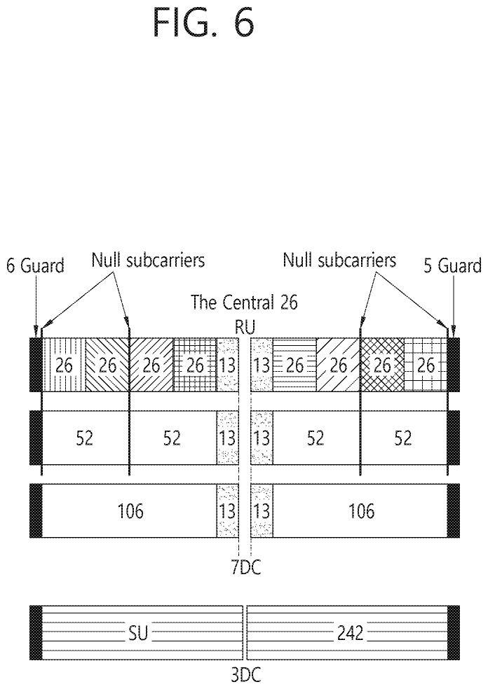

The PPDU of FIG. 5 can be related to various PPDU types used in a UHR system. For example, the example of FIG. 5 can be used for at least one of single-user (SU) mode/type/transmission, multi-user (MU) mode/type/transmission, and null-data packet (NDP) mode/type/transmission related to channel sounding. For example, if the example of FIG. 5 is related to NDP, the data field illustrated can be omitted. If the PPDU of FIG. 5 is used for trigger-based (TB) mode, UHR-SIG of FIG. 6 can be omitted. In other words, an STA that has received a trigger frame for uplink-MU (UL-MU) communication can transmit a PPDU with UHR-SIG omitted in the example of FIG. 5.

In FIG. 5, L-STF or UHR-LTF may be called a preamble or a physical preamble, and may be generated/transmitted/received/acquired/decoded in the physical layer (included in the transmitting/receiving STA).

Each block illustrated in FIG. 5 may be called a field/subfield/signal, etc. The names of these fields/subfields/signals may be legacy short training field (L-STF), legacy long training field (L-LTF), legacy signal (L-SIG), repeated L-SIG (RL-SIG), universal signal (U-SIG), UHR-signal (UHR-SIG), etc., as illustrated in FIG. 5.

A subcarrier spacing of the L-STF, L-LTF, L-SIG, RL-SIG, U-SIG, and UHR-SIG fields of FIG. 5 may be determined as 312.5 kHz, and a subcarrier spacing of the UHR-STF, UHR-LTF, and Data fields may be determined as 78.125 kHz. That is, a tone index (or subcarrier index) of the L-STF, L-LTF, L-SIG, RL-SIG, U-SIG, and UHR-SIG fields may be expressed in unit of 312.5 kHz, and a tone index (or subcarrier index) of the UHR-STF, UHR-LTF, and Data fields may be expressed in unit of 78.125 kHz.

In the PPDU of FIG. 5, the L-LTF and the L-STF may be the same as those in the conventional fields (for example, non-HT LTF and non-HT STF defined in conventional WLAN standards).

The L-SIG field of FIG. 5 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-high throughput (HT), high throughput (HT), very high throughput (VHT) PPDU, extremely high throughput (EHT) PPDU or UHR PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI, EHT PPDU or the UHR PPDU, the value of the length field may be determined as a multiple of 3, and for the high efficiency (HE) PPDU, the value of the length field may be determined as “a multiple of 3”+1 or “a multiple of 3”+2. In other words, the LENGTH field in an UHR PPDU is set to a value satisfying the condition that the remainder is zero when LENGTH is divided by 3

For example, the (non-AP and AP) STA may apply BCC encoding based on a ½ coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {−1, −1, −1, 1} to a subcarrier index {−28, −27, +27, +28}. The aforementioned signal may be used for channel estimation in the frequency domain corresponding to {−28, −27, +27, +28}.

For example, the (non-AP and AP) STA may generate an RL-SIG generated in the same manner as the L-SIG. BPSK modulation may be applied to the RL-SIG. The (non-AP and AP) STA may know that the RX PPDU is the HE PPDU, EHT PPDU, or the UHR PPDU, based on the presence of the RL-SIG. In other words, a receiving (non-AP and AP) STA can know that a received PPDU is one of a HE PPDU, an EHT PPDU, and a UHR PPDU if RL-SIG is present. In other words, a receiving (non-AP and AP) STA can know that a received PPDU is one of a non-HT PPDU, an HT PPDU, and a VHT PPDU if RL-SIG is not present. In other words, the RL-SIG field is a repeat of the L-SIG field and is used to differentiate a UHR PPDU from a non-HT PPDU, HT PPDU, and VHT PPDU.

A universal SIG (U-SIG) may be inserted after the RL-SIG of FIG. 6. The U-SIG may be called in various terms such as a first SIG field, a first SIG, a first type SIG, a control signal, a control signal field, a first (type) control signal, common control field, common control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 us. Each symbol of the U-SIG may be used to transmit the 26-bit information. For example, each symbol of the U-SIG may be transmitted/received based on 52 data tomes and 4 pilot tones.

Through the U-SIG for example, A-bit information (e.g., 52 un-coded bits) may be transmitted. A first symbol of the U-SIG may transmit first X-bit information (e.g., 26 un-coded bits) of the A-bit information, and a second symbol of the U-SIG may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=½ to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, ‘000000’.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits (for example, 000 value) may indicate that the TX/RX PPDU is an EHT PPDU. Also, a second value of the PHY version identifier of 3 bits (for example, 001 value) may indicate that the TX/RX PPDU is a UHR PPDU.

In other words, when the (AP/non-AP) STA transmits an EHT PPDU, the 3-bit PHY version identifier can be set to the first value, and when the (AP/non-AP) STA transmits a UHR PPDU, the 3-bit PHY version identifier can be set to the second value. In other words, the receiving (AP/non-AP) STA can determine that the received PPDU is an EHT PPDU based on the PHY version identifier having the first value, and can determine that the received PPDU is a UHR PPDU based on the PHY version identifier having the second value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a transmission opportunity (TXOP) length and information related to a BSS color ID.

For example, if a UHR PPDU is classified into various types (e.g., type related to SU transmission (performed based on UL or DL), type related to DL transmission, type related to NDP transmission, type related to DL non-MU-MIMO, type related to DL MU-MIMO, type related to multi-AP operation, type related to coordinated beamforming (Co-BF), spatial reuse (SR), type related to coordinated OFDMA (C-OFDMA), type related to coordinated TDMA (Co-TDMA)), information about the type of the UHR PPDU (e.g., 2-bit or 3-bit information) can be included in the version-dependent bits of the U-SIG.

For example, the U-SIG may include: 1) a bandwidth field including information related to a bandwidth; 2) a field including information related to an modulation and coding scheme (MCS) applied to UHR-SIG; 3) an indication field including information regarding whether a dual subcarrier modulation (DCM) scheme is applied to UHR-SIG; 4) a field including information related to the number of symbol used for UHR-SIG; 5) a field including information regarding whether the UHR-SIG is generated across a full band; 6) a field including information related to a type of UHR-LTF/STF; and 7) information related to a field indicating an UHR-LTF length and a CP length.

Preamble puncturing may be applied to the PPDU of FIG. 5. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 MHaz band within the 160 MHz band (or 80+80 MHz band).

Information related to the preamble puncturing applied to the PPDU may be included in U-SIG and/or UHR-SIG. For example, a first field of the U-SIG may include information related to a contiguous bandwidth, and second field of the U-SIG may include information related to the preamble puncturing applied to the PPDU.

For example, the U-SIG and the UHR-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an UHR-SIG contiguous to the first U-SIG may include information related to a preamble puncturing applied to the second 80 MHz band (i.e., information related to a preamble puncturing pattern), and an UHR-SIG contiguous to the second U-SIG may include information related to a preamble puncturing (i.e., information related to a preamble puncturing pattern) applied to the first 80 MHz band.

Additionally or alternatively, the U-SIG and the UHR-SIG may include the information related to the preamble puncturing, based on the following method. The U-SIG may include information related to a preamble puncturing (i.e., information related to a preamble puncturing pattern) for all bands. That is, the UHR-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The UHR-SIG of FIG. 5 may include control information for the receiving STA. The UHR-SIG may be transmitted through at least one symbol, and one symbol may have a length of 4 us. Information related to the number of symbols used for the UHR-SIG may be included in the U-SIG.

UHR-SIG provides an additional signal to the U-SIG field to enable STA to interpret/decode UHR PPDU. UHR-SIG field may include U-SIG overflow bits that are commonly applied to all users. In addition, UHR-SIG field includes resource allocation information, so that STA can look-up resources used in fields including data field/UHR-STF/UHR-LTF (i.e., UHR modulated fields of a UHR PPDU).

Frequency resources of UHR-LTF, UHR-STF, and data fields illustrated in FIG. 5 may be determined based on RUs (resource units) defined by multiple subcarriers/tones. That is, UHR-LTF, UHR-STF, and data fields of the present disclosure may be transmitted/received through RUs (resource units) defined by multiple subcarriers/tones.

FIG. 6 is a diagram illustrating the layout of resource units (RUs) used for a 20 MHz PPDU. That is, the UHR-LTF, UHR-STF, and/or data fields included in the 20 MHz PPDU may be transmitted/received through at least one of the various RUs defined in FIG. 6.

As illustrated in the uppermost part of FIG. 6, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

Meanwhile, the layout of the RUs in FIG. 6 may be used not only for a multiple users (MUs) but also for a single user (SU), in which case one 242-unit may be used and three DC tones may be inserted as illustrated in the lowermost part of FIG. 6.

Although FIG. 6 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones). In this specification, N-RU may be represented as N-tone RU, etc. For example, 26-RU may be represented as 26-tone RU.

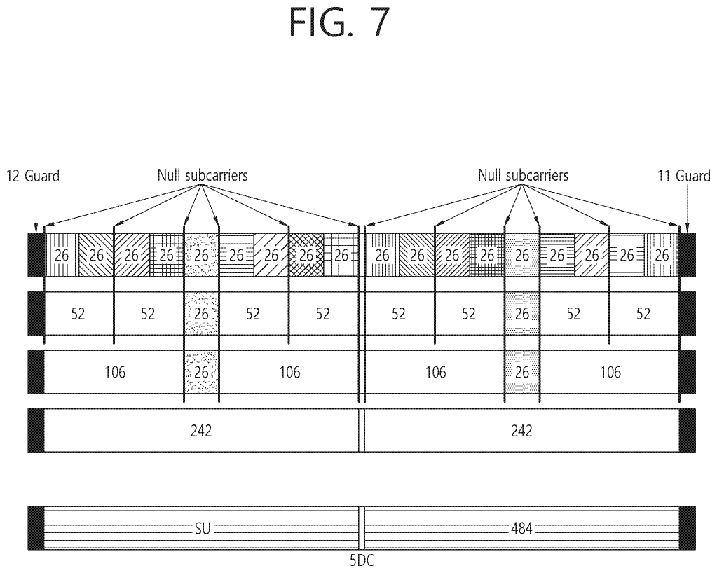

FIG. 7 is a diagram illustrating the layout of resource units (RUs) used for 40 MHz PPDU.

Similarly to FIG. 6 in which RUs having various sizes are used, a 26-RU, a 52-RU, a 106-RU, a 242-RU, a 484-RU, and the like may be used in an example of FIG. 7. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 7, when the layout of the RUs is used for a single user, a 484-RU may be used. The specific number of RUs may be changed similarly to FIG. 6.

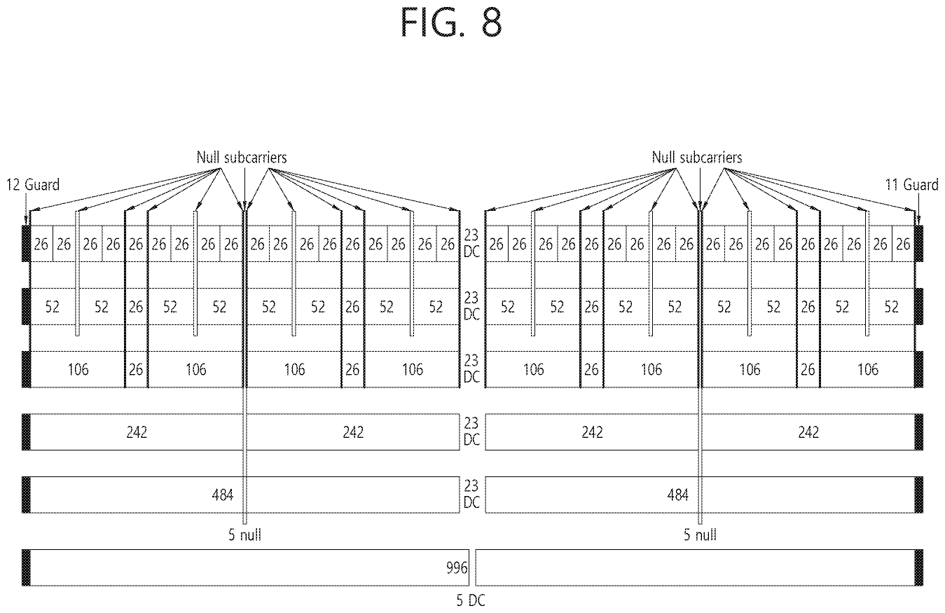

FIG. 8 is a diagram illustrating the layout of resource units (RUs) used for an 80 MHz PPDU. The layout of resource units (RUs) used in this specification may vary. For example, the layout of resource units (RUs) used in the 80 MHz band may vary.

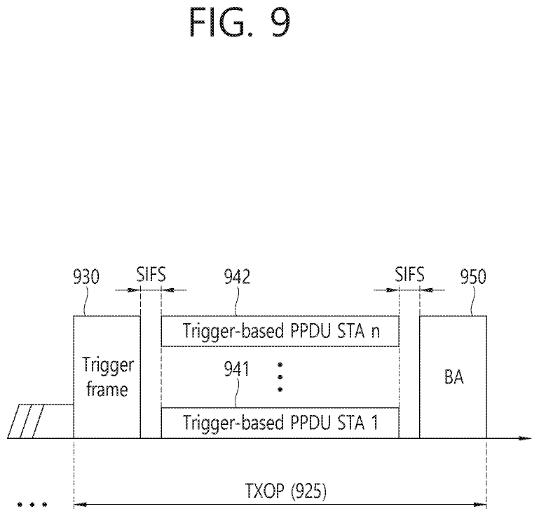

FIG. 9 shows an operation related to UL-MU. As illustrated, a transmitting STA (e.g., AP) can perform channel access through contending (i.e., backoff operation) and transmit a trigger frame (930). That is, the transmitting STA (e.g., AP) can transmit a PPDU including a trigger frame (930). When a PPDU including a trigger frame is received, a TB (trigger-based) PPDU is transmitted after a delay of SIFS.

TB PPDUs (941, 942) are transmitted at the same time and can be transmitted from multiple STAs (e.g., User STAs) whose AIDs are indicated in the Trigger frame (930). The ACK frame (950) for the TB PPDU can be implemented in various forms.

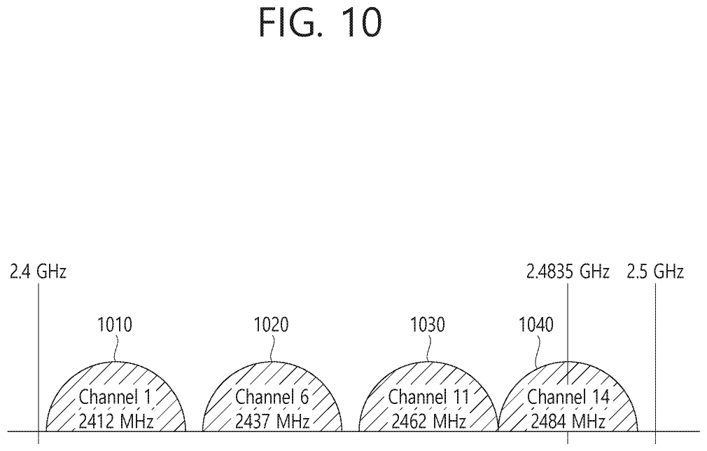

FIG. 10 illustrates an example of channels used/supported/defined within the 2.4 GHz band.

The 2.4 GHz band may also be referred to by other names, such as “first band.” Furthermore, the 2.4 GHz band may refer to a frequency range in which channels with center frequencies adjacent to 2.4 GHz (e.g., channels with center frequencies between 2.4 and 2.5 GHz) are used/supported/defined.

The 2.4 GHz band may include multiple 20 MHz channels. The 20 MHz within the 2.4 GHz band may have multiple channel indices (e.g., indices 1 through 14). For example, the center frequency of a 20 MHz channel assigned channel index 1 may be 2.412 GHz, the center frequency of a 20 MHz channel assigned channel index 2 may be 2.417 GHz, and the center frequency of a 20 MHz channel assigned channel index N may be (2.407+0.005*N) GHz. The channel indices may be referred to by various names, such as channel numbers. The specific numerical values of the channel indices and center frequencies may change.

FIG. 10 exemplarily illustrates four channels within the 2.4 GHz band. The illustrated first frequency region (1010) to fourth frequency region (1040) may each include one channel. For example, the first frequency region (1010) may include channel 1 (a 20 MHz channel having an index of 1). In this case, the center frequency of channel 1 may be set to 2412 MHz. The second frequency region (1020) may include channel 6. In this case, the center frequency of channel 6 may be set to 2437 MHz. The third frequency region (1030) may include channel 11. In this case, the center frequency of channel 11 may be set to 2462 MHz. The fourth frequency region (1040) may include channel 14. In this case, the center frequency of channel 14 may be set to 2484 MHz.

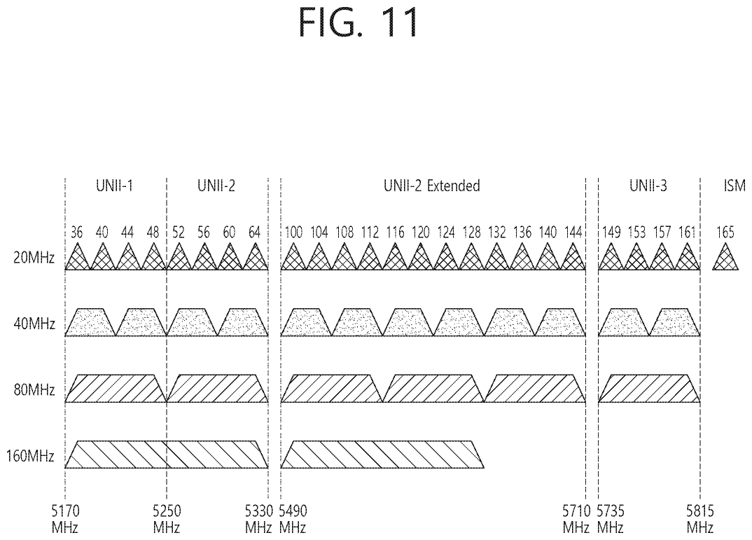

FIG. 11 illustrates an example of channels used/supported/defined within the 5 GHz band.

The 5 GHz band may be referred to by other names, such as a second band/band, etc. The 5 GHz band may refer to a frequency range in which channels with center frequencies greater than or equal to 5 GHz and less than 6 GHZ (or less than 5.9 GHZ) are used/supported/defined. Alternatively, the 5 GHz band may include multiple channels between 4.5 GHz and 5.5 GHz. The specific figures shown in FIG. 11 are subject to change.

Multiple channels within the 5 GHz band include Unlicensed National Information Infrastructure (UNII)-1, UNII-2, UNII-3, and ISM. UNII-1 may be referred to as UNII Low. UNII-2 may include frequency ranges called UNII Mid and UNII-2Extended. UNII-3 may be referred to as UNII-Upper.

Within the 5 GHz band, multiple channels can be configured, and the bandwidth of each channel can be variously configured, such as 20 MHz, 40 MHz, 80 MHz, or 160 MHz. For example, the 5170 MHz to 5330 MHz frequency domain/range within UNII-1 and UNII-2 can be divided into eight 20 MHz channels. The 5170 MHz to 5330 MHz frequency domain/range can be divided into four channels through a 40 MHz frequency domain. The 5170 MHz to 5330 MHz frequency domain/range can be divided into two channels through an 80 MHz frequency domain. Alternatively, the 5170 MHz to 5330 MHz frequency domain/range can be divided into one channel through a 160 MHz frequency domain.

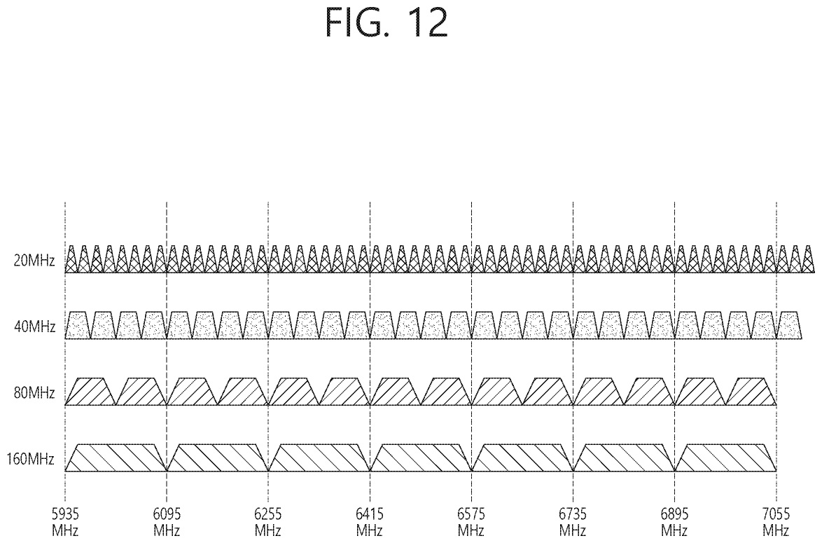

FIG. 12 illustrates an example of channels used/supported/defined within the 6 GHz band.

The 6 GHz band may be referred to by other names, such as the third band/band. The 6 GHz band may refer to a frequency range where channels with center frequencies higher than 5.9 GHz are used, supported, and defined. The specific values shown in FIG. 12 are subject to change.

For example, the 20 MHz channel in FIG. 12 may be defined starting from 5.940 GHz. Specifically, the leftmost channel among the 20 MHz channels in FIG. 12 may have an index of 1 (or channel index, channel number, etc.) and be assigned a center frequency of 5.945 GHz. In other words, the center frequency of channel index N may be determined as (5.940+0.005*N) GHz.

Accordingly, the indexes (or channel numbers) of the 20 MHz channels of FIG. 12 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. Also, according to the (5.940+0.005*N) GHz rule mentioned above, the indexes of the 40 MHz channels in FIG. 12 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Hereinafter, the structure and type/subtype of MAC frame are described.

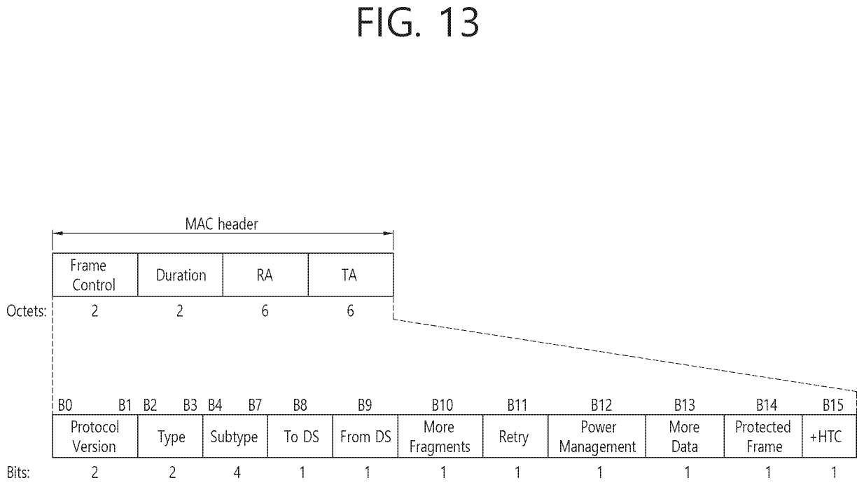

FIG. 13 shows an example of a header of a MAC frame. As shown, the MAC frame can include a frame control field/information of 2 octets in length, a duration field/information of 2 octets in length, an receiver address (RA) field/information of 6 octets in length, and a transmitter address (TA) field/information of 6 octets in length. As shown in FIG. 13, the four fields can be consecutive to each other. The MAC header of FIG. 13 can be modified in various ways, and a new field can be inserted between the four fields shown, or at least one of the fields shown can be omitted.

The MAC header shown in FIG. 13 can be located at the very front of the MAC frame. That is, the MAC frame may include a MAC header as in FIG. 13 and a MAC body field/information that is continuous to the MAC header. The MAC frame including the MAC header of FIG. 13 is inserted/included in the data field of the PPDU (e.g., UHR PPDU) illustrated in FIG. 5.

The MAC frame included in the data field of the PPDU of this disclosure may be classified into various types. For example, the MAC frame of this disclosure may be classified into a control frame, a management frame, and a data frame.

For example, the management frame includes association request, association response, reassociation request, reassociation response, probe request, probe response, beacon, disassociation, authentication, and deauthentication frames/signals defined in the conventional WLAN. For the management frame, the values of the type fields (B3 and B2) of FIG. 8 are set to 00. Also, the values of the subtype fields (B7, B6, B5, B4) of FIG. 8 are as follows: association request (0000), association response (0001), reassociation request (0010), reassociation response (0011), probe request (0100), probe response (0101), beacon (1000), disassociation (1010), authentication (1011), deauthentication (1100).

For example, the control frame includes trigger beamforming report poll, NDP announcement (NDPA), control frame extension, control wrapper, block Ack request (BlockAckReq), Block Ack (BlockAck), PS-Poll, RTS, CTS, Ack, CF-end frames/signals defined in conventional WLAN. For the control frame, the values of the type fields (B3 and B2) of FIG. 8 are set to 01. Also, the values of the subtype fields (B7, B6, B5, B4) of FIG. 8 are as follows: trigger (0010), beamforming report poll (0100), NDP announcement (0101), control frame extension (0110), control wrapper (0111), BlockAckReq (1000), BlockAck (1001), PS-Poll (1010), RTS (1011), CTS (1100), Ack (1101), CF-End (1110).

For example, the data frame includes (QoS) Data, (QoS) Null, etc. defined in the conventional WLAN. For the management frame, the values of the type fields (B3 and B2) of FIG. 13 are set to 10.

The MAC frame/signal used in this disclosure can be identified through the type field/information and subtype field/information described above. For example, a “trigger frame” in this disclosure may mean a MAC frame in which the type bits B3 and B2 bits in the frame control field of the MAC header are set to 01, and the subtype bits B7, B6, B5, and B4 bits in the frame control field are set to 0010. Various MAC frames described in this disclosure are inserted/included in the data fields of various PPDUs (e.g., HE/VHT/HE/EHT/UHR PPDUs).

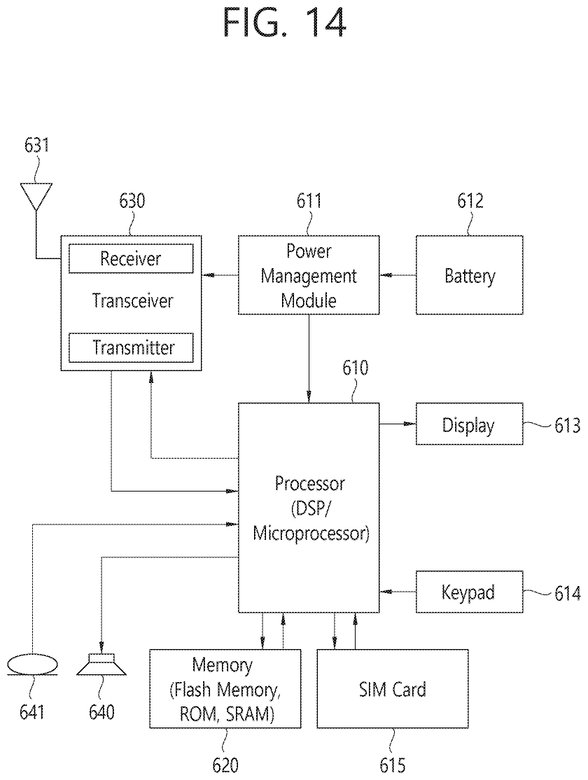

FIG. 14 shows a modified example of a transmitting device and/or a receiving device of the present disclosure.

The devices (e.g., AP STA, non-AP STA) shown in FIGS. 1 to 4 can be modified as shown in FIG. 14. The transceiver 630 of FIG. 14 can be identical to the transceiver 113, 123 of FIG. 1. The transceiver 630 of FIG. 14 can include a receiver and a transmitter.

The processor 610 of FIG. 14 can be identical to the processor 111, 121 of FIG. 1. Alternatively, the processor 610 of FIG. 14 can be identical to the processing chip 114, 124 of FIG. 1.

The memory 150 of FIG. 14 may be the same as the memory 112, 122 of FIG. 1. Alternatively, the memory 150 of FIG. 14 may be a separate external memory different from the memory 112, 122 of FIG. 1.

Referring to FIG. 14, the power management module 611 manages power for the processor 610 and/or the transceiver 630. The battery 612 supplies power to the power management module 611. The display 613 outputs the result processed by the processor 610. The keypad 614 receives input to be used by the processor 610. The keypad 614 may be displayed on the display 613. The SIM card 615 may be an integrated circuit used to securely store an international mobile subscriber identity (IMSI) and its associated keys, which are used to identify and authenticate subscribers in mobile devices such as mobile phones and computers.

Referring to FIG. 14, the speaker (640) may output sound-related results processed by the processor 610. The microphone (641) may receive sound-related input to be used by the processor 610.

Below, the EHT-SIG field applicable to this specification is described.

The EHT-SIG field provides additional signals to the U-SIG field to enable STAs to interpret the EHT MU PPDU. In an EHT MU PPDU, the EHT-SIG field contains U-SIG overflow bits common to all users. The EHT-SIG field further contains resource allocation information that allows STAs to query the corresponding resources to be used in the EHT modulated field of the PPDU. The integer fields of the EHT-SIG field are transmitted in unsigned binary format (LSB first), where the least significant bit (LSB) is in the lowest bit position.

The EHT-SIG field of a 20 MHz EHT MU PPDU contains one EHT-SIG content channel. For OFDMA transmission and non-OFDMA transmission for multiple users, the EHT-SIG field of a 40 MHz or 80 MHz EHT MU PPDU contains two EHT-SIG content channels.

For OFDMA transmissions and non-OFDMA transmissions for multiple users, the EHT-SIG field of an EHT MU PPDU that is 160 MHz or wider contains two EHT-SIG content channels per 80 MHz frequency subblock. When the bandwidth of an EHT MU PPDU for OFDMA transmission is wider than 80 MHz, the EHT-SIG content channels per 80 MHz frequency subblock may carry different information. The EHT-SIG field of an EHT SU transmission or the EHT-SIG field of an EHT sounding NDP contains one EHT-SIG content channel, which is duplicated for each non-punctured 20 MHz subchannel when the EHT PPDU is 40 MHz or wider.

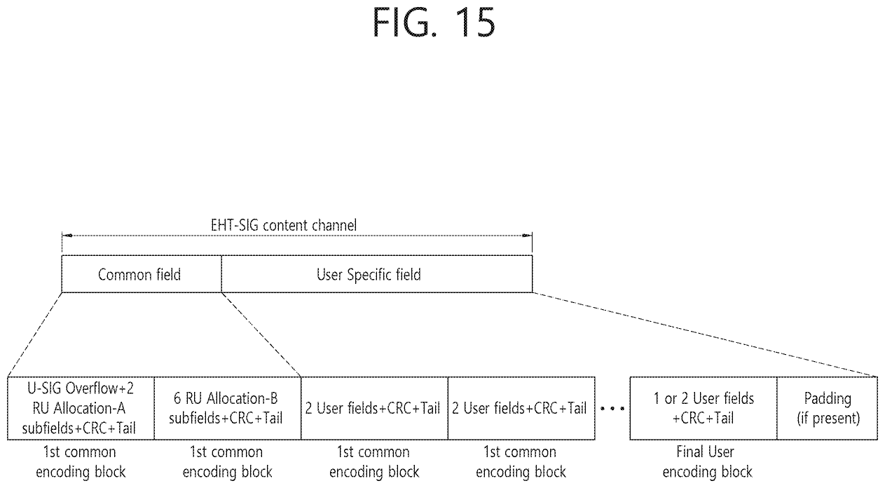

FIG. 15 illustrates an example of an EHT-SIG content channel for 320 MHz OFDMA transmission.

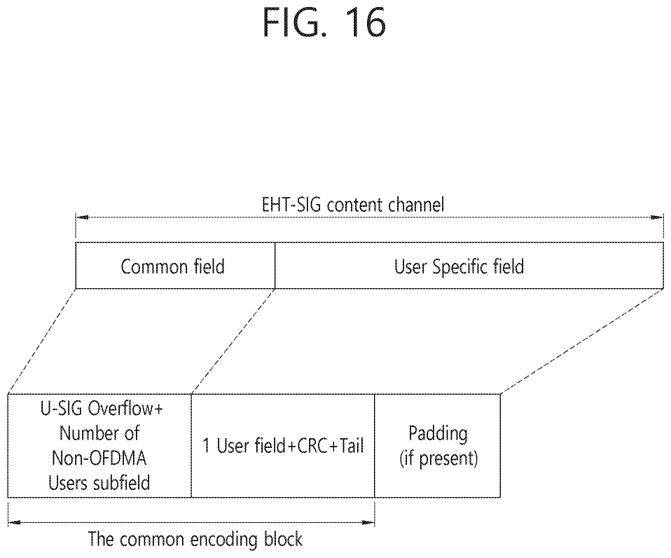

FIG. 16 illustrates an example of an EHT-SIG content channel for EHT SU transmission.

For OFDMA transmission, the common field of the EHT-SIG content channel contains information about resource unit allocation, such as RU allocation to be used in the EHT modulated field of the PPDU, RU allocated to MU-MIMO, and the number of users in the MU-MIMO allocation. The common field consists of one or two common encoding blocks.

In non-OFDMA transmissions, the common field of the EHT-SIG content channel does not include an RU allocation subfield. For non-OFDMA transmissions, excluding EHT sounding NDP, the common field of the EHT-SIG content channel is encoded with the first user field, and this encoded block contains a CRC and a tail, referred to as the common encoding block.

The user-specific field combination of the EHT-SIG content channel contains information on how to decode the payload for all users in the PPDU.

The common field for the OFDMA transmission includes an RU Allocation subfield.

The RU Allocation-A subfield located at B17−B16+9N in the above common field is defined as follows. N RU Allocation-A subfields exist in the EHT-SIG content channel, and if the bandwidth field of the U-SIG field is 0 or 1, N is set to 1, and if the bandwidth field of the U-SIG field is 2, 3, 4, or 5, N is set to 2.

Each RU Allocation-A subfield of the EHT-SIG content channel corresponding to a 20 MHz frequency subchannel indicates an RU or MRU allocation, including the size of the RU or MRU and its arrangement in the frequency domain.

Each Allocation-A subfield also indicates the information necessary to calculate the number of users assigned to each RU or MRU.

In the common field, the RU Allocation-B subfield located at B27+9N−B26+9N+9M is defined as follows. When the bandwidth subfield of the U-SIG field indicates a 160 MHz, 320 MHz-1 or 320 MHz-2 EHT MU PPDU, M RU Allocation-B subfields are present in the EHT-SIG content channel. Here, M is equal to 2 or 6 as follows. When the bandwidth field of the U-SIG field is 3, M is set to 2. When the bandwidth field of the U-SIG field is 4 or 5, Mis set to 6.

Each RU Allocation-B subfield of the EHT-SIG content channel corresponding to a 20 MHz frequency subchannel indicates an RU or MRU allocation, including its size and frequency-domain arrangement. This is used in the EHT modulated field of the EHT MU PPDU in the frequency domain.

Each RU Allocation-B subfield also indicates the information necessary to calculate the number of users allocated to each RU or MRU.

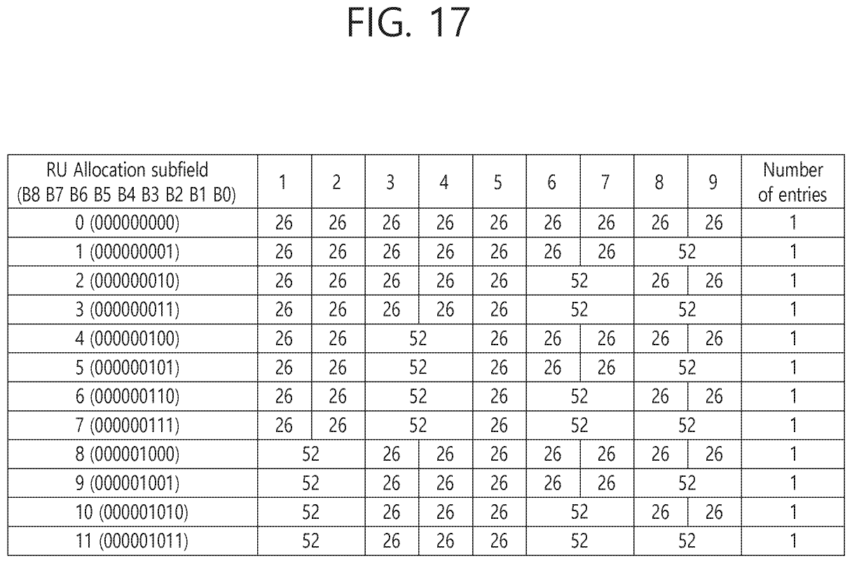

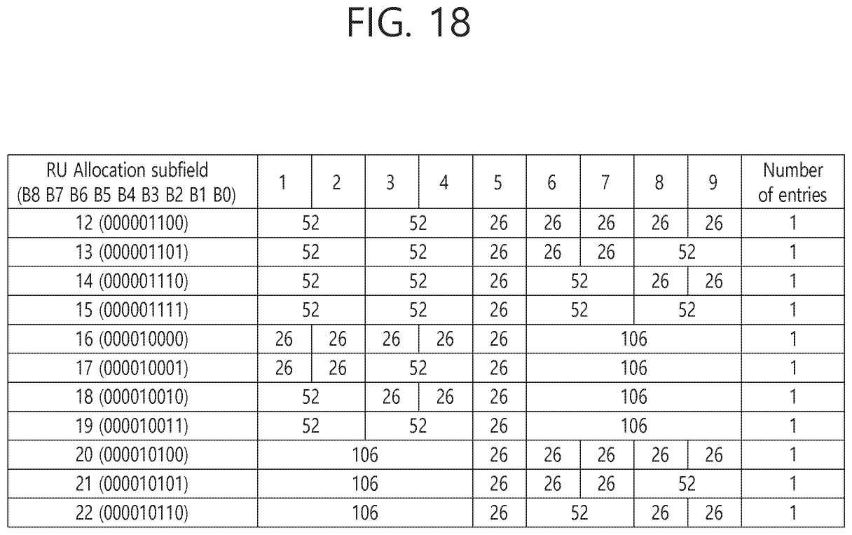

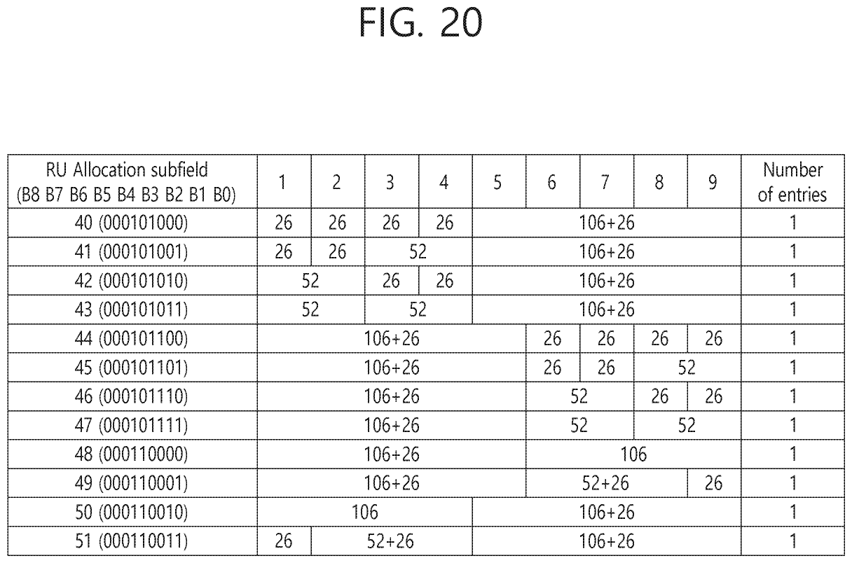

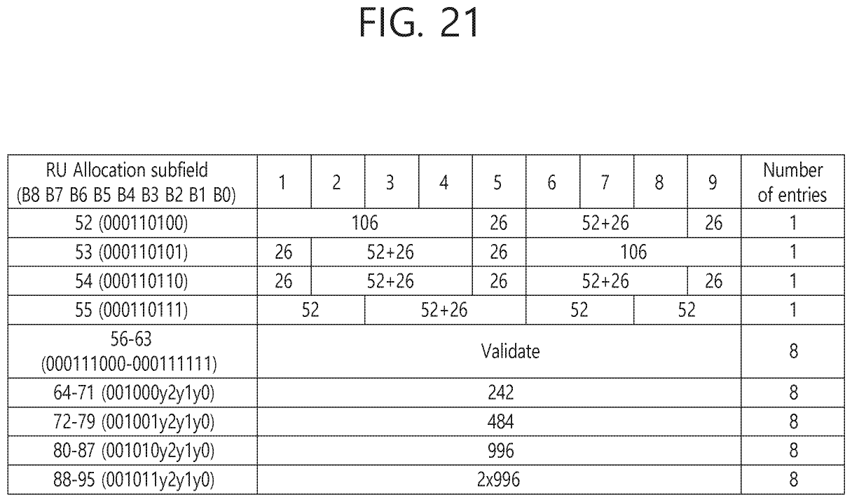

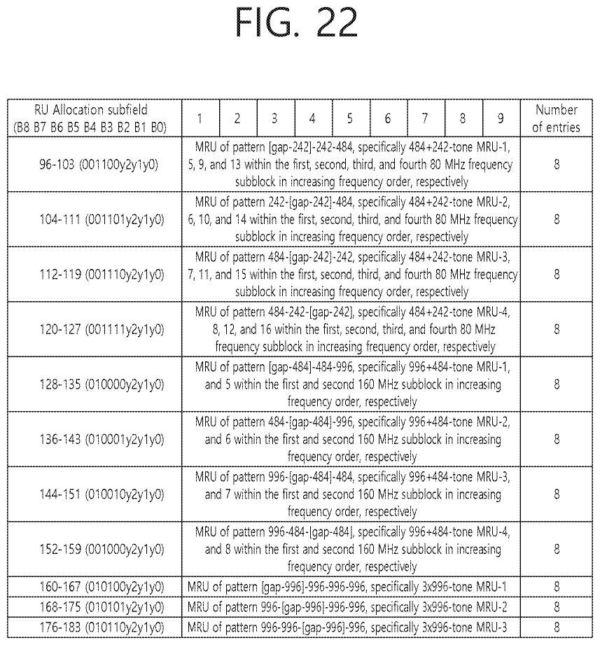

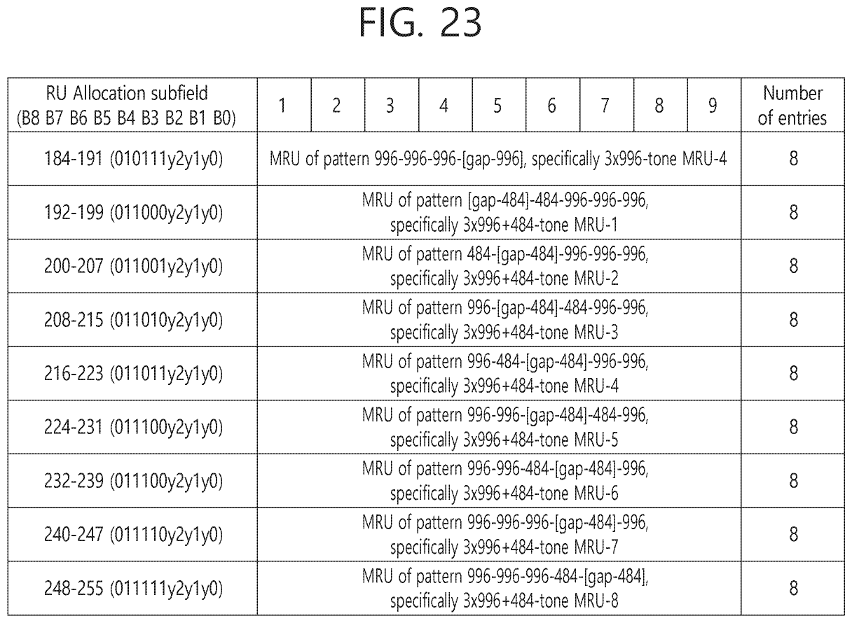

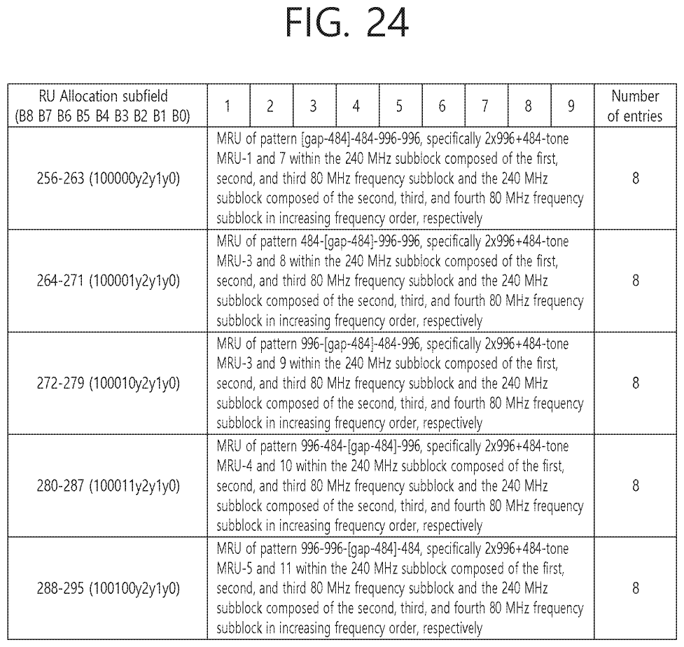

FIGS. 17 to 25 illustrates an example of an RU Allocation subfield defined in an 802.11be WLAN system.

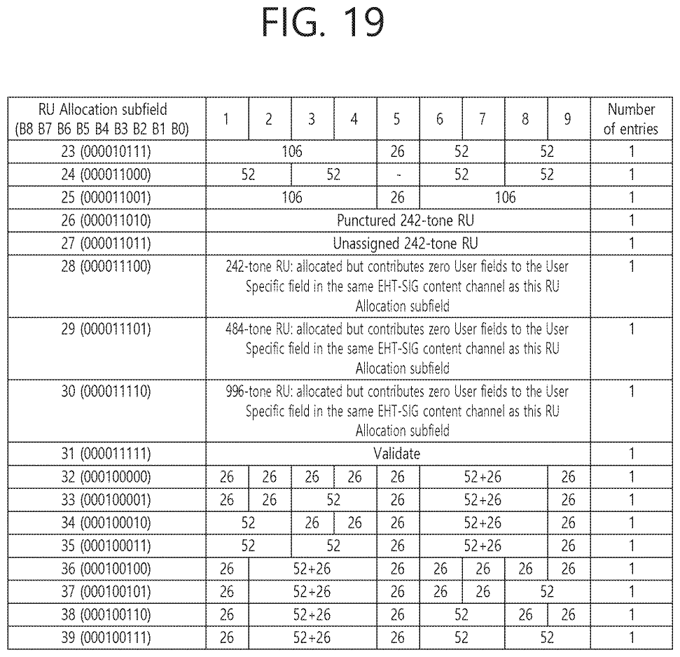

The mapping from the 9-bit RU Allocation subfield to RU allocation and the number of User fields per RU or MRU contributed to the User Specific field of the same EHT-SIG content channel as the RU Allocation subfield are defined in FIGS. 19 to 27.

Referring to FIGS. 17 to 25, when the value of the RU Allocation subfield is 0 to 303, it indicates an allocation pattern of a specific RU or MRU, and when the value of the RU Allocation subfield is 304 to 511, it is set to Disregard.

The large-size MRUs defined for DL and UL non-OFMDA transmissions are as follows:
: 484+242-tone MRU, 996+484-tone MRU, 996+484+242-tone MRU, 2×996+484-tone MRU, 3×996-tone MRU, and 3×996+484-tone MRU

The large-size MRUs defined for DL and UL OFMDA transmissions are as follows:
: 484+242-tone MRU, 996+484-tone MRU, 2×996+484-tone MRU, 3×996-tone MRU, and 3×996+484-tone MRU (i.e., the 996+484+242-tone MRU is defined only for non-OFDMA transmissions).

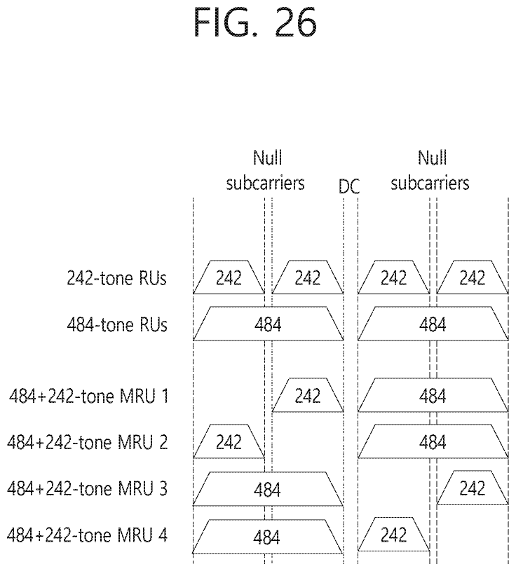

FIG. 26 illustrates the arrangement of 484+242-tone MRUs in an 80 MHz bandwidth.

Referring to FIG. 26, for non-OFDMA 80 MHz EHT PPDU, 484+242-tone MRU is defined only when 20 MHz subchannel is punctured. 484+242-tone MRU is obtained by combining 484-tone RU and 242-tone RU in non-OFDMA 80 MHz EHT PPDU. The data subcarrier of 484+242-tone MRU is composed of the data subcarriers of 484 tone RU and 242 tone RU that make up 484+242-tone MRU. The pilot subcarrier of 484+242 tone MRU is composed of the pilot subcarriers of 484-tone RU and 242-tone RU that make up 484+242-tone MRU. The four 484+242-tone MRUs allowed in a non-OFDMA 80 MHz EHT PPDU are shown in FIG. 26.

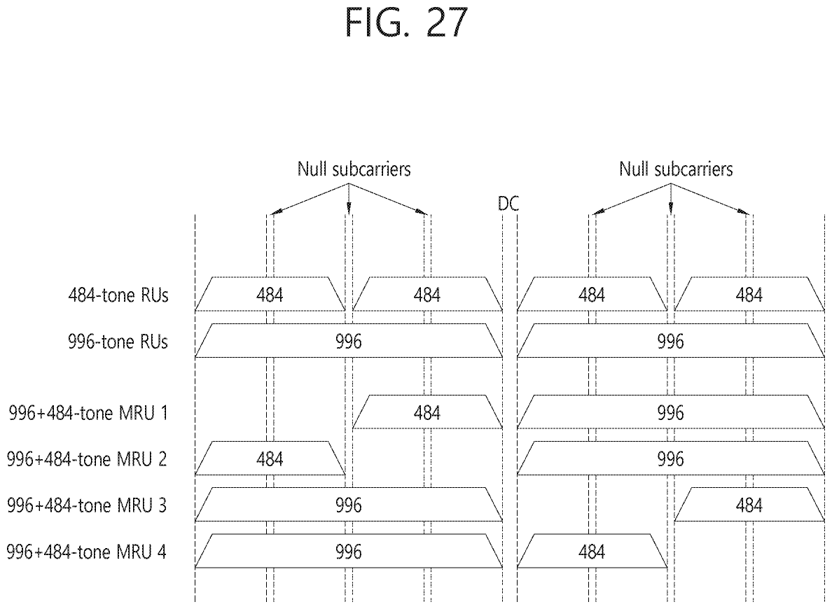

FIG. 27 illustrates the arrangement of 996+484-tone MRUs in a 160 MHz bandwidth.

Referring to FIG. 27, for non-OFDMA 160 MHz EHT PPDU, 996+484-tone MRU is defined only when 40 MHz subchannel is punctured. 996+484-tone MRU is obtained by combining 996-tone RU and 484-tone RU in non-OFDMA 160 MHz EHT PPDU. The data subcarrier of 996+484-tone MRU is composed of the data subcarriers of 996-tone RU and 484-tone RU that make up 996+484-tone MRU. The pilot subcarrier of 996+484-tone MRU is composed of the pilot subcarriers of 996-tone RU and 484-tone RU that make up 996+484-tone MRU. The four 996+484-tone MRUs allowed in a non-OFDMA 160 MHz EHT PPDU are shown in FIG. 27.

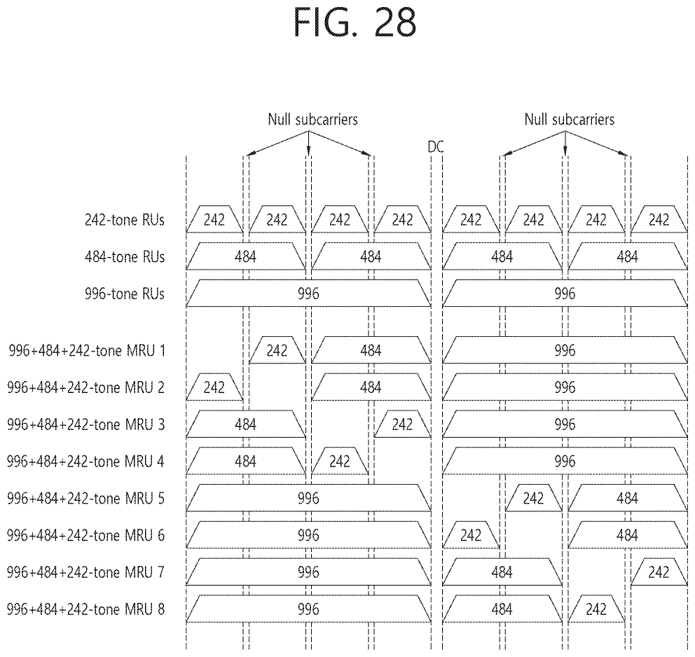

FIG. 28 illustrates the arrangement of 996+484+242-tone MRUs in a 160 MHz bandwidth.

Referring to FIG. 28, for non-OFDMA 160 MHz EHT PPDU, 996+484+242-tone MRU is defined only when 20 MHz subchannel is punctured. 996+484+242-tone MRU is obtained by combining 996-tone RU, 484-tone RU, and 242-tone RU in non-OFDMA 160 MHz EHT PPDU. The data subcarrier of 996+484+242-tone MRU is composed of a set of data subcarriers of 996-tone, 484-tone, and 242-tone RU that configure 996+484+242-tone MRU. The pilot subcarrier of the 996+484+242-tone MRU is composed of a set of pilot subcarriers of the 996-tone, 484-tone, and 242-tone RUs that configure the 996+484-+-242-tone MRU. The eight 996+484+242-tone MRUs allowed in a non-OFDMA 160 MHz EHT PPDU are shown in FIG. 28.

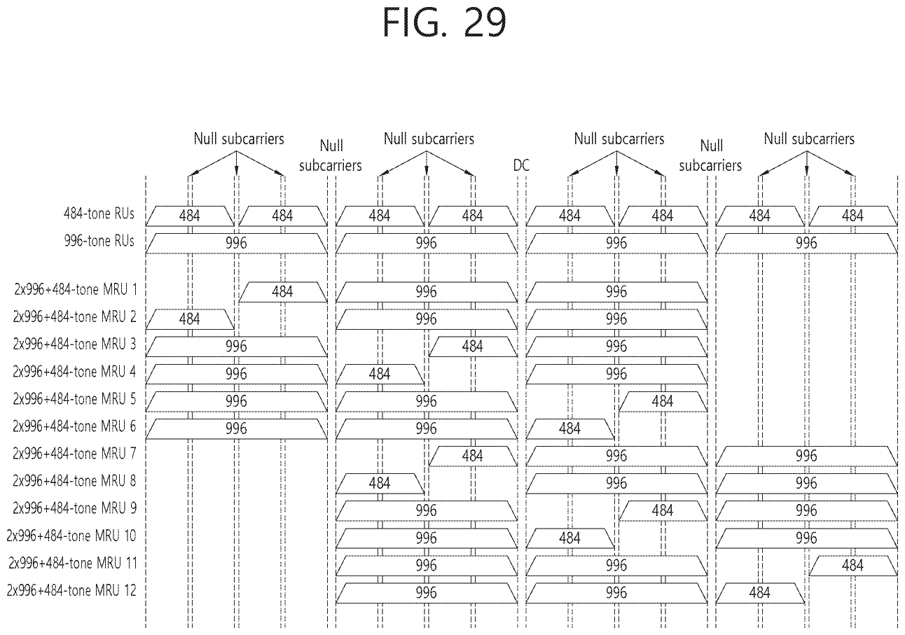

FIG. 29 illustrates the arrangement of 2×996+484-tone MRUs in a 320 MHz bandwidth.

Referring to FIG. 29, for non-OFDMA 320 MHz EHT PPDU, 2×996+484-tone MRU is defined only when 996-tone RU1 or 996-tone RU4 is punctured and one of the 40 MHz subchannels of the remaining 240 MHz is punctured. 2×996+484-tone MRU is obtained by combining two 996-tone RUs and a 484-tone RU in a non-OFDMA 320 MHz EHT PPDU. The data subcarrier of the 2×996+484-tone MRU is composed of the combination of the data subcarriers of the two 996-tone RUs that make up the 2×996+484-tone MRU and the 484-tone RU. The pilot subcarrier of the 2×996+484-tone MRU is composed of the combination of the pilot subcarriers of the two 996-tone RUs that make up the 2×996+484-tone MRU and the 484-tone RU. The twelve 2×996+484-tone MRUs allowed in a non-OFDMA 320 MHz EHT PPDU are shown in FIG. 29 (2×996+484-tone MRUs allowed in a non-OFDMA 320 MHz EHT PPDU). If any of 2×996+484-tone MRU 1 to 2×996+484-tone MRU 6 is used, the highest 80 MHz frequency subblock in the frequency is punctured. If any of 2×996+484-tone MRU 7 to 2×996+484-tone MRU 12 is used, the lowest 80 MHz frequency subblock in the frequency is punctured.

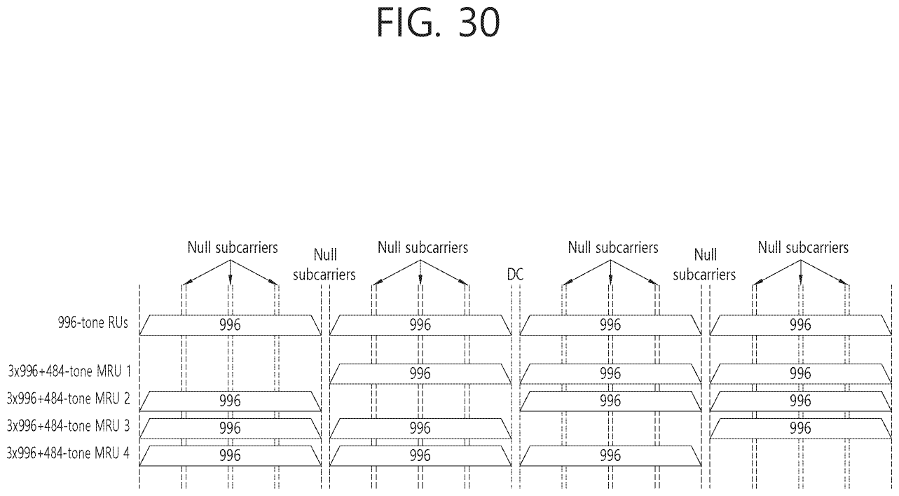

FIG. 30 illustrates the layout of 3×996-tone MRUs in a 320 MHz bandwidth.

Referring to FIG. 30, for non-OFDMA 320 MHz EHT PPDU, 3×996-tone MRU is defined only when 80 MHz subchannel is punctured. 3×996-tone MRU is obtained by combining three 996-tone RUs in non-OFDMA 320 MHz EHT PPDU. The data subcarrier of a 3×996-tone MRU is composed of the data subcarriers of the three 996-tone RUs that make up the 3×996-tone MRU. The pilot subcarrier of a 3×996-tone MRU is composed of the pilot subcarriers of three 996-ton RUs that make up the 3×996-tone MRU. Four 3×996-tone MRUs allowed in non-OFDMA 320 MHz EHT PPDU are shown in FIG. 30.

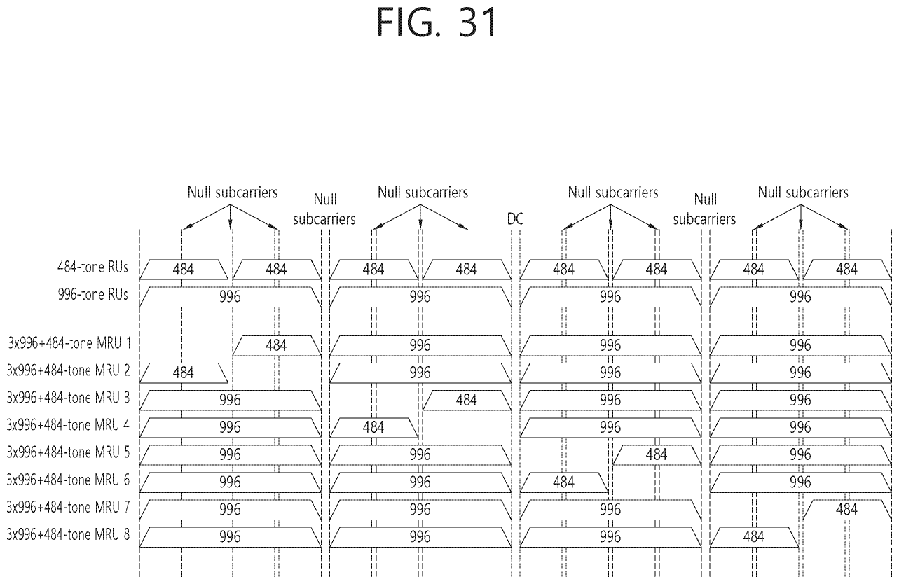

FIG. 31 illustrates the layout of 3×996+484-tone MRUs in a 320 MHz bandwidth.

Referring to FIG. 31, for non-OFDMA 320 MHz EHT PPDU, 3×996+484-tone MRU is defined only when 40 MHz subchannel is punctured. 3×996+484-tone MRU is obtained by combining three 996-tone RUs and one 484-tone RU in non-OFDMA 320 MHz EHT PPDU. The data subcarrier of 3×996+484-tone MRU is formed by the union of the data subcarriers of the three 996-tone RUs and the 484-tone RU that make up the 3×996+484 tone MRU. The pilot subcarrier of 3×996+484-tone MRU is formed by the union of the pilot subcarriers of the three 996-tone RUs and the 484-tone RU that make up the 3×996+484 tone MRU. The eight 3×996+484-tone MRUs allowed in a non-OFDMA 320 MHz EHT PPDU are shown in FIG. 31.

The location of the large size MRU is fixed and defined as follows. Table I defines the index of the large size MRU in OFDMA 80 MHz PPDU and non-OFDMA 80 MHz PPDU.

TABLE 1

| MRU type | MRU index | Combinations |
|---|---|---|
| 484 + 242- | MRU 1 | 484-tone RU 2 + 242-tone RU 2; [(gap-242-tone RU) − 242- |
| tone MRU | | tone RU − 484-tone RU] |
| | MRU 2 | 484-tone RU 2 + 242-tone RU 1; [242-tone RU − (gap-242-tone |
| | | RU) − 484-tone RU] |
| | MRU 3 | 484-tone RU 1 + 242-tone RU 4; [484-tone RU − (gap-242-tone |
| | | RU) − 242-tone RU] |
| | MRU 4 | 484-tone RU 1 + 242-tone RU 3; [484-tone RU − 242-tone RU − |
| | | (gap-242-tone RU)] |

NOTE 1—
gap-242-tone RU is not part of an MRU and is used to indicate the size of a gap between or beside RUs that form the MRU.
NOTE 2—
non-OFDMA transmission, gap-242-tone RU indicates that one 20 MHz subchannel corresponding to gap-242-tone RU is punctured and is to help indicate the frequency order of the MRU in an 80 MHz PPDU.
NOTE 3—
OFDMA transmission, gap-242-tone RU indicates that one 20 MHz subchannel corresponding to gap-242-tone RU is either punctured or unassigned or assigned to other RUs or MRUs for data transmission, and is to help indicate the frequency order of the MRU within an 80 MHz EHT PPDU.

Tables 2 to 4 define the indices of large size MRUs in OFDMA 160 MHz PPDUs and non-OFDMA 160 MHz PPDUs.

TABLE 2

| MRU type | MRU index | Combinations |
|---|---|---|
| 484 + 242- | MRU 1 | 484-tone RU 2 + 242-tone RU 2; [(gap-242-tone RU) − 242- |
| tone MRU | | tone RU − 484-tone RU] in lower 80 MHz channel |
| (only for | MRU 2 | 484-tone RU 2 + 242-tone RU 1; [242-tone RU − (gap-242-tone |
| OFDMA) | | RU) − 484-tone RU] in lower 80 MHz channel |
| | MRU 3 | 484-tone RU 1 + 242-tone RU 4; [484-tone RU − (gap-242-tone |
| | | RU) − 242-tone RU] in lower 80 MHz channel |
| | MRU 4 | 484-tone RU 1 + 242-tone RU 3; [484-tone RU − 242-tone RU − |
| | | (gap-242-tone RU)] in lower 80 MHz channel |
| | MRU 5 | 484-tone RU 4 + 242-tone RU 6; [(gap-242-tone RU) − 242- |
| | | tone RU − 484-tone RU] in upper 80 MHz channel |
| | MRU 6 | 484-tone RU 4 + 242-tone RU 5; [242-tone RU − (gap-242-tone |
| | | RU) − 484-tone RU] in upper 80 MHz channel |
| | MRU 7 | 484-tone RU 3 + 242-tone RU 8; [484-tone RU − (gap-242-tone |
| | | RU) − 242-tone RU] in upper 80 MHz channel |
| | MRU 8 | 484-tone RU 3 + 242-tone RU 7; [484-tone RU − 242-tone RU − |
| | | (gap-242-tone RU)] in upper 80 MHz channel |

NOTE 1—
RU is not part of an MRU and is used to indicate the size of a gap between or beside RUs that form the MRU.
NOTE 2—
non-OFDMA transmission, gap-242/484-tone RU indicates that one or more 20 MHz subchannels corresponding to gap-242/484-tone RU are punctured and is to help indicate the frequency order of the MRU in a 160 MHz PPDU.
NOTE 3—
OFDMA transmission, gap-242/484-tone RU indicates that one or more 20 MHz subchannels corresponding to gap-242/484-tone RU are either punctured or unassigned or assigned to other RUs or MRUs for data transmission, and is to help indicate the frequency order of the MRU within a 160 MHz EHT PPDU.

TABLE 3

| MRU type | MRU index | Combinations |
|---|---|---|
| 996 + 484- | MRU 1 | 996-tone RU 2 + 484-tone RU 2; [(gap-484-tone RU) − 484- |
| tone MRU | | tone RU − 996-tone RU] |
| | MRU 2 | 996-tone RU 2 + 484-tone RU 1; [484-tone RU − (gap-484-tone |
| | | RU) − 996-tone RU] |
| | MRU 3 | 996-tone RU 1 + 484-tone RU 4; [996-tone RU − (gap-484-tone |
| | | RU) − 484-tone RU] |
| | MRU 4 | 996-tone RU 1 + 484-tone RU 3; [996-tone RU − 484-tone RU − |
| | | (gap-484-tone RU)] |

NOTE 1—
RU is not part of an MRU and is used to indicate the size of a gap between or beside RUs that form the MRU.
NOTE 2—
non-OFDMA transmission, gap-242/484-tone RU indicates that one or more 20 MHz subchannels corresponding to gap-242/484-tone RU are punctured and is to help indicatethe frequency order of the MRU in a 160 MHz PPDU.
NOTE 3—
OFDMA transmission, gap-242/484-tone RU indicates that one or more 20 MHz subchannels corresponding to gap-242/484-tone RU are either punctured or unassigned or assigned to other RUs or MRUs for data transmission, and is to help indicate the frequencyorder of the MRU within a 160 MHz EHT PPDU.

TABLE 4

| MRU type | MRU index | Combinations |
|---|---|---|
| 996 + 484 + 242- | MRU 1 | 996-tone RU 2 + 484-tone RU 2 + 242-tone RU 2; [(gap- |
| tone MRU (only | | 242-tone RU) − 242-tone - RU 484-tone RU − 996-tone RU] |
| for non- | MRU 2 | 996-tone RU 2 + 484-tone RU 2 + 242-tone RU 1; [242- |
| OFDMA) | | tone RU − (gap-242-tone RU) − 484-tone RU − 996-tone |
| | | RU] |
| | MRU 3 | 996-tone RU 2 + 484-tone RU 1 + 242-tone RU 4; [484- |
| | | tone RU − (gap-242-tone RU) − 242-tone RU − 996-tone |
| | | RU] |
| | MRU 4 | 996-tone RU 2 + 484-tone RU 1 + 242-tone RU 3; [484- |
| | | tone RU − 242-tone RU − (gap-242-tone RU) − 996-tone |
| | | RU] |
| | MRU 5 | 996-tone RU 1 + 484-tone RU 4 + 242-tone RU 6; [996- |
| | | tone RU − (gap-242-tone RU) − 242-tone RU − 484-tone |
| | | RU] |
| | MRU 6 | 996-tone RU 1 + 484-tone RU 4 + 242-tone RU 5; [996- |
| | | tone RU − 242-tone RU − (gap-242-tone RU) − 484-tone |
| | | RU] |
| | MRU 7 | 996-tone RU 1 + 484-tone RU 3 + 242-tone RU 8; [996- |
| | | tone RU − 484-tone RU − (gap-242-tone RU) − 242-tone |
| | | RU |
| | MRU 8 | 996-tone RU 1 + 484-tone RU 3 + 242-tone RU 7; [996- |
| | | tone RU − 484-tone RU − 242-tone RU − (gap-242-tone |
| | | RU)] |

NOTE 1—
RU is not part of an MRU and is used to indicate the size of a gap between or beside RUs that form the MRU.
NOTE 2—
non-OFDMA transmission, gap-242/484-tone RU indicates that one or more 20 MHz subchannels corresponding to gap-242/484-tone RU are punctured and is to help indicate the frequency order of the MRU in a 160 MHz PPDU.
NOTE 3—
OFDMA transmission, gap-242/484-tone RU indicates that one or more 20 MHz subchannels corresponding to gap-242/484-tone RU are either punctured or unassigned or assigned to other RUs or MRUs for data transmission, and is to help indicate the frequency order of the MRU within a 160 MHz EHT PPDU.

Tables 5 to 9 define the indices of large size MRUs in OFDMA 320 MHz PPDUs and non-OFDMA 320 MHz PPDUs.

TABLE 5

| MRU type | MRU index | Combinations |
|---|---|---|
| 484 + 242- | MRU 1 | 484-tone RU 2 + 242-tone RU 2; [(gap-242-tone RU) − 242- |
| tone MRU | | tone RU − 484-tone RU] in lower 80 MHz channel in lower 160 |
| (only for | | MHZ |
| OFDMA) | MRU 2 | 484-tone RU 2 + 242-tone RU 1; [242-tone RU − (gap-242-tone |
| | | RU) − 484-tone RU] in lower 80 MHz channel in lower 160 |
| | | MHz |
| | MRU 3 | 484-tone RU 1 + 242-tone RU 4; [484-tone RU − (gap-242-tone |
| | | RU) − 242-tone RU] in lower 80 MHz channel in lower 160 |
| | | MHz |
| | MRU 4 | 484-tone RU 1 + 242-tone RU 3; [484-tone RU − 242-tone RU − |
| | | (gap-242-tone RU)] in lower 80 MHz channel in lower 160 |
| | | MHZ |
| | MRU 5 | 484-tone RU 4 + 242-tone RU 6; [(gap-242-tone RU) − 242- |
| | | tone RU − 484-tone RU] in upper 80 MHz channel in lower 160 |
| | | MHz |
| | MRU 6 | 484-tone RU 4 + 242-tone RU 5; [242-tone RU − (gap-242-tone |
| | | RU) − 484-tone RU] in upper 80 MHz channel in lower 160 |
| | | MHz |
| | MRU 7 | 484-tone RU 3 + 242-tone RU 8; [484-tone RU − (gap-242-tone |
| | | RU) − 242-tone RU] in upper 80 MHz channel in lower 160 |
| | | MHZ |
| | MRU 8 | 484-tone RU 3 + 242-tone RU 7; [484-tone RU − 242-tone RU − |
| | | (gap-242-tone RU)] in upper 80 MHz channel in lower 160 |
| | | MHZ |
| | MRU 9 | 484-tone RU 6 + 242-tone RU 10; [(gap-242-tone RU) − 242- |
| | | tone RU − 484-tone RU] in lower 80 MHz channel in upper 160 |
| | | MHz |
| | MRU 10 | 484-tone RU 6 + 242-tone RU 9; [242-tone RU − (gap-242-tone |
| | | RU) − 484-tone RU] in lower 80 MHz channel in upper 160 |
| | | MHz |
| | MRU 11 | 484-tone RU 5 + 242-tone RU 12; [484-tone RU − (gap-242- |
| | | tone RU) − 242-tone RU] in lower 80 MHz channel in upper |
| | | 160 MHz |
| | MRU 12 | 484-tone RU 5 + 242-tone RU 11; [484-tone RU − 242-tone |
| | | RU − (gap-242-tone RU)] in lower 80 MHz channel in upper 160 |
| | | MHz |
| | MRU 13 | 484-tone RU 8 + 242-tone RU 14; [(gap-242-tone RU) − 242- |
| | | tone RU − 484-tone RU] in upper 80 MHz channel in upper 160 |
| | | MHz |
| | MRU 14 | 484-tone RU 8 + 242-tone RU 13; [242-tone RU − (gap-242- |
| | | tone RU) − 484-tone RU] in upper 80 MHz channel in upper |
| | | 160 MHz |
| | MRU 15 | 484-tone RU 7 + 242-tone RU 16; [484-tone RU − (gap-242- |
| | | tone RU) − 242-tone RU] in upper 80 MHz channel in upper |
| | | 160 MHZ |
| | MRU 16 | 484-tone RU 7 + 242-tone RU 15; [484-tone RU − 242-tone |
| | | RU − (gap-242-tone RU)] in upper 80 MHz channel in upper 160 |
| | | MHz |

NOTE 1—
RU is not part of an MRU and is used to indicate the size of a gap between or beside RUs that form the MRU.
NOTE 2—
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3—
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 6

| MRU type | MRU index | Combinations |
|---|---|---|
| 996 + 484- | MRU 1 | 996-tone RU 2 + 484-tone RU 2; [(gap-484-tone RU) − 484- |
| tone MRU | | tone RU − 996-tone RU] in lower 160 MHZ |
| (only for | MRU 2 | 996-tone RU 2 + 484-tone RU 1; [484-tone RU − (gap-484-tone |
| OFDMA) | | RU) − 996-tone RU] in lower 160 MHZ |
| | MRU 3 | 996-tone RU 1 + 484-tone RU 4; [996-tone RU − (gap-484-tone |
| | | RU) − 484-tone RU] in lower 160 MHz |
| | MRU 4 | 996-tone RU 1 + 484-tone RU 3; [996-tone RU − 484-tone RU − |
| | | (gap-484-tone RU)] in lower 160 MHZ |
| | MRU 5 | 996-tone RU 4 + 484-tone RU 6; [(gap-484-tone RU) − 484- |
| | | tone RU − 996-tone RU] in upper 160 MHz |
| | MRU 6 | 996-tone RU 4 + 484-tone RU 5; [484-tone RU − (gap-484-tone |
| | | RU) − 996-tone RU] in upper 160 MHz |
| | MRU 7 | 996-tone RU 3 + 484-tone RU 8; [996-tone RU − (gap-484-tone |
| | | RU) − 484-tone RU] in upper 160 MHz |
| | MRU 8 | 996-tone RU 3 + 484-tone RU 7; [996-tone RU − 484-tone RU − |
| | | (gap-484-tone RU)] in upper 160 MHz |

NOTE 1—
RU is not part of an MRU and is used to indicate the size of a gap between or beside RUs that form the MRU.
NOTE 2—
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3—
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 7

| MRU type | MRU index | Combinations |
|---|---|---|
| 2 × 996 + 484- | MRU 1 | 996-tone RU 2 + 996-tone RU 3 + 484-tone RU 2; [(gap-484- |
| tone MRU | | tone RU) − 484-tone RU − 996-tone RU − 996-tone RU − (gap- |
| | | 996-tone RU)] |
| | MRU 2 | 996-tone RU 2 + 996-tone RU 3 + 484-tone RU 1; [484-tone |
| | | RU − (gap-484-tone RU) − 996-tone RU − 996-tone RU − (gap- |
| | | 996-tone RU)] |
| | MRU 3 | 996-tone RU 1 + 996-tone RU 3 + 484-tone RU 4; [996-tone |
| | | RU − (gap-484-tone RU) − 484-tone RU − 996-tone RU − (gap- |
| | | 996-tone RU)] |
| | MRU 4 | 996-tone RU 1 + 996-tone RU 3 + 484-tone RU 3; [996-tone |
| | | RU − 484-tone RU − (gap-484-tone RU) − 996-tone RU − (gap- |
| | | 996-tone RU)] |
| | MRU 5 | 996-tone RU 1 + 996-tone RU 2 + 484-tone RU 6; [996-tone |
| | | RU − 996-tone RU − (gap-484-tone RU) − 484-tone RU − (gap- |
| | | 996-tone RU)] |
| | MRU 6 | 996-tone RU 1 + 996-tone RU 2 + 484-tone RU 5; [996-tone |
| | | RU − 996-tone RU − 484-tone RU − (gap-484-tone RU) − (gap- |
| | | 996-tone RU)] |
| | MRU 7 | 996-tone RU 3 + 996-tone RU 4 + 484-tone RU 4; [(gap-996- |
| | | tone RU) − (gap-484-tone RU) − 484-tone RU − 996-tone RU − |
| | | 996-tone RU] |
| | MRU 8 | 996-tone RU 3 + 996-tone RU 4 + 484-tone RU 3; [(gap-996- |
| | | tone RU) − 484-tone RU − (gap-484-tone RU) − 996-tone RU − |
| | | 996-tone RU] |
| | MRU 9 | 996-tone RU 2 + 996-tone RU 4 + 484-tone RU 6; [(gap-996- |
| | | tone RU) − 996-tone RU − (gap-484-tone RU) − 484-tone RU − |
| | | 996-tone RU] |
| | MRU 10 | 996-tone RU 2 + 996-tone RU 4 + 484-tone RU 5; [(gap-996- |
| | | tone RU) − 996-tone RU − 484-tone RU − (gap-484-tone RU) − |
| | | 996-tone RU] |
| | MRU 11 | 996-tone RU 2 + 996-tone RU 3 + 484-tone RU 8; [(gap-996- |
| | | tone RU) − 996-tone RU − 996-tone RU − (gap-484-tone RU) − |
| | | 484-tone RU] |
| | MRU 12 | 996-tone RU 2 + 996-tone RU 3 + 484-tone RU 7; [(gap-996- |
| | | tone RU) − 996-tone RU − 996-tone RU − 484-tone RU − (gap- |
| | | 484-tone RU)] |

NOTE 1—
RU is not part of an MRU and is used to indicate the size of a gap between or beside RUs that form the MRU.
NOTE 2—
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3—
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 8

| MRU type | MRU index | Combinations |
|---|---|---|
| 3 × 996-tone | MRU 1 | 996-tone RU 2 + 996-tone RU 3 + 996-tone RU 4; [(gap-996- |
| MRU | | tone RU) − 996-tone RU − 996-tone RU − 996-tone RU] |
| | MRU 2 | 996-tone RU 1 + 996-tone RU 3 + 996-tone RU 4; [996-tone |
| | | RU − (gap-996-tone RU) − 996-tone RU − 996-tone RU] |
| | MRU 3 | 996-tone RU 1 + 996-tone RU 2 + 996-tone RU 4; [996-tone |
| | | RU − 996-tone RU − (gap-996-tone RU) − 996-tone RU] |
| | MRU 4 | 996-tone RU 1 + 996-tone RU 2 + 996-tone RU 3; [996-tone |
| | | RU − 996-tone RU − 996-tone RU − (gap-996-tone RU)] |

NOTE 1—
RU is not part of an MRU and is used to indicate the size of a gap between or beside RUs that form the MRU.
NOTE 2—
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3—
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

TABLE 9

| MRU type | MRU index | Combinations |
|---|---|---|
| 3 × 996 + 484- | MRU 1 | 996-tone RU 2 + 996-tone RU 3 + 996-tone RU 4 + 484-tone |
| tone MRU | | RU 2; [(gap-484-tone RU) − 484-tone RU − 996-tone RU − |
| | | 996-tone RU − 996-tone RU] |
| | MRU 2 | 996-tone RU 2 + 996-tone RU 3 + 996-tone RU 4 + 484-tone |
| | | RU 1; [484-tone RU − (gap-484-tone RU) − 996-tone RU − |
| | | 996-tone RU − 996-tone RU] |
| | MRU 3 | 996-tone RU 1 + 996-tone RU 3 + 996-tone RU 4 + 484-tone |
| | | RU 4; [996-tone RU − (gap-484-tone RU) − 484-tone RU − |
| | | 996-tone RU − 996-tone RUJ |
| | MRU 4 | 996-tone RU 1 + 996-tone RU 3 + 996-tone RU 4 + 484-tone |
| | | RU 3; [996-tone RU − 484-tone RU − (gap-484-tone RU) − |
| | | 996-tone RU − 996-tone RU] |
| | MRU 5 | 996-tone RU 1 + 996-tone RU 2 + 996-tone RU 4 + 484-tone |
| | | RU 6; [996-tone RU − 996-tone RU − (gap-484-tone RU) − |
| | | 484-tone RU − 996-tone RU] |
| | MRU 6 | 996-tone RU 1 + 996-tone RU 2 + 996-tone RU 4 + 484-tone |
| | | RU 5; [996-tone RU − 996-tone RU − 484-tone RU − (gap-484- |
| | | tone RU) − 996-tone RU] |
| | MRU 7 | 996-tone RU 1 + 996-tone RU 2 + 996-tone RU 3 + 484-tone |
| | | RU 8; [996-tone RU − 996-tone RU − 996-tone RU − (gap-484- |
| | | tone RU) − 484-tone RU] |
| | MRU 8 | 996-tone RU 1 + 996-tone RU 2 + 996-tone RU 3 + 484-tone |
| | | RU 7; [996-tone RU − 996-tone RU − 996-tone RU − 484-tone |
| | | RU − (gap-484-tone RU)] |

NOTE 1—
RU is not part of an MRU and is used to indicate the size of a gap between or beside RUs that form the MRU.
NOTE 2—
non-OFDMA transmission, gap-242/484/996-tone RU indicates that one or more 20 MHz subchannels corresponding to gap-242/484/996-tone RU are punctured and is to help indicate the frequency order of the MRU in a 320 MHz PPDU.
NOTE 3—
OFDMA transmission, gap-242/484/996-tone RU indicates that one or more 20 MHz subchannels corresponding to gap-242/484/996-tone RU are either punctured or unassigned or assigned to other RUs or MRUs for data transmission, and is to help indicate the frequency order of the MRU within a 320 MHz EHT PPDU.

The user-specific fields of the EHT-SIG content channel consist of zero or more user-encoded blocks and padding (if any), as shown in FIGS. 15 and 16.

For DL OFDMA transmissions (in the U-SIG field, the UL/DL fields are set to 0 and the PPDU Type And Compression Mode field is set to 0), the number of user fields is indicated by the RU Allocation subfield.

Each non-final user encoding block consists of two user fields containing information for the two STAs used to decode the payload. The final user encoding block contains information for one or two users, depending on the number of user fields in the EHT-SIG content channel.

For EHT SU transmissions (UL/DL fields in the U-SIG field are set to 0 or 1, PPDU Type And Compression Mode field is set to 1, and EHT-SIG MCS field and Number of EHT-SIG Symbols field are not set to 0 at the same time) and for DL non-OFDMA transmissions for multiple users (UL/DL fields in the U-SIG field are set to 0 and PPDU Type And Compression Mode field is set to 2), the number of users is indicated by the Number Of Non-OFDMA Users subfield.

The common fields of the EHT-SIG content channel are encoded together with the first user field of the same content channel. This common encoding block contains a CRC and a tail.

For non-OFDMA transmissions for multiple users, a user encoding block exists if the content channel contains more than one user field.

There are N user fields in the user encoding block, as follows: This is the end-user encoding block. If there is only one user in the end-user encoding block, N=1; otherwise, N=2.

The formats of the user fields for non-MU-MIMO allocation and MU-MIMO allocation are defined separately.

The user fields for non-MU-MIMO allocation include the STA-ID subfield, MCS subfield, Reserved subfield, NSS subfield, Beamformed subfield, and Coding subfield. The user fields for MU-MIMO allocation include the STA-ID subfield, MCS subfield, Coding subfield, and Spatial Configuration subfield.

Below, the NDPA frame used in the NDP sounding procedure is described.

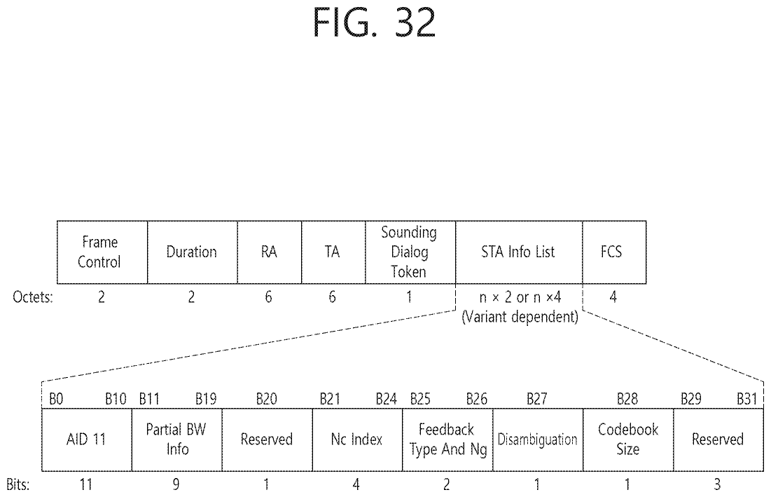

FIG. 32 illustrates an example of an NDP Announcement frame format.

The NDP Announcement frame has three variants: the VHT NDP Announcement frame, the HE NDP Announcement frame, and the EHT NDP Announcement frame. Each variant is distinguished by the configuration of the HE subfield and the Ranging subfield within the Sounding Dialog Token field.

The VHT/HE/EHT NDP Announcement frame contains at least one STA Info field. If the VHT/HE/EHT NDP Announcement frame contains only one STA Info field, the RA field is set to the address of an STA that can provide feedback. If the VHT/HE/EHT NDP Announcement frame contains more than one STA Info field, the RA field is set to the broadcast address.

The TA field is set to the address of the STA transmitting the VHT/HE/EHT NDP Announcement frame or the bandwidth signaling TA of the STA transmitting the VHT/HE/EHT NDP Announcement frame.

The Resolution subfield of the Partial BW Info subfield indicates the resolution bandwidth for each bit of the Feedback Bitmap subfield. The Feedback Bitmap subfield indicates the request for each resolution bandwidth from the lowest frequency to the highest frequency, with B1 indicating the lowest resolution bandwidth. Each bit of the Feedback Bitmap subfield is set to 1 if feedback is requested for the corresponding resolution bandwidth.

The Resolution bit indicates the feedback resolution bandwidth. The Resolution bit is set to 0 to indicate a resolution of 20 MHz when the BW subfield is set to 0 to 3, and is set to 1 to indicate a resolution of 40 MHz when the BW subfield is set to 4. The Feedback Bitmap subfield indicates each resolution bandwidth for which the beamformer requests feedback. Each bit in the Feedback Bitmap subfield is set to 1 if feedback is requested for the corresponding bandwidth, and 0 otherwise.

If the bandwidth of the EHT NDP Announcement frame is less than 320 MHz, the Resolution bit B0 is set to 0 to indicate a resolution of 20 MHz.
When the bandwidth of the EHT NDP Announcement frame is 20 MHz, B1 is set to 1 to indicate a feedback request for a 242-tone RU. B2-B8 are reserved and set to 0.
When the bandwidth of the EHT NDP Announcement frame is 40 MHz, B1 and B2 indicate feedback requests for each of the two 242-tone RUs, from low to high frequency. B3-B8 are reserved and set to 0.
When the bandwidth of the EHT NDP Announcement frame is 80 MHz, B1 to B4 represent feedback requests for each of the four 242-tone RUs, from low frequency to high frequency. B5 to B8 are reserved and set to 0. If B1 to B4 are all set to 1, it represents a feedback request for the 996-tone RU.
When the bandwidth of the EHT NDP Announcement frame is 160 MHz, B1-B8 represent feedback requests for each of the eight 242-tone RUs from low to high frequency. If B1-B4 are all set to 1, it represents a feedback request for the lower 996-tone RU, and if B5-B8 are all set to 1, it represents a feedback request for the upper 996-tone RU.

When the bandwidth of the EHT NDP Announcement frame is 320 MHz, the Resolution bit B0 is set to 1 to indicate a resolution of 40 MHz. B1 to B8 represent feedback requests for each of the eight 484-tone RUs from low to high frequency. When B1 and B2 are both set to 1, it represents a feedback request for the lowest 996-tone RU, when B3 and B4 are both set to 1, it represents a feedback request for the second-lowest 996-tone RU, when B5 and B6 are both set to 1, it represents a feedback request for the second-highest 996-tone RU, and when B7 and B8 are both set to 1, it represents a feedback request for the highest 996-tone RU.

The sounding protocol can be described as follows. Since the standardization stage has not yet been finalized, the sounding protocol described below was developed for EHT wireless LAN systems, but it can also be applied to UHR wireless LAN systems or next-generation wireless LAN systems.

Transmit beamforming and Downlink Multi-User-Multi-Input-Multi-Output (DL MU-MIMO) require knowledge of the channel conditions to compute a steering matrix applied to the transmitted signal to optimize reception at one or more receivers. The EHT STA determines the channel condition information using the EHT sounding protocol. The EHT sounding protocol provides an explicit feedback mechanism, defined as EHT non-trigger-based (non-TB) sounding and EHT trigger-based (TB) sounding. Here, the EHT beamformee measures the channel using training signals transmitted by the EHT beamformer (i.e., the EHT sounding NDP) and sends back a transformed estimate of the channel condition. The EHT beamformer uses this estimate to derive the steering matrix.

EHT Beamformer returns an estimate of the channel state from an EHT compressed Beamforming/CQI report contained in one or more EHT Compressed Beamforming/CQI frames. There are three types of EHT compressed Beamforming/CQI reports.
SU Feedback: EHT Compressed Beamforming/CQI report consists of EHT Compressed Beamforming report field.
MU Feedback: The EHT Compressed Beamforming/CQI report consists of an EHT Compressed Beamforming report field and an EHT MU Exclusive Beamforming report field.
CQI Feedback: EHT Compressed Beamforming/CQI reporting consists of the EHT CQI report field.

Note that the use of EHT TB sounding does not necessarily imply MU feedback. EHT TB sounding is also used to obtain SU feedback and CQI feedback.

### Embodiments Applicable to this Specification

In 802.11be, MRU is defined by considering various preamble puncturing patterns and channel conditions in SU/MU transmission to efficiently use wide bandwidth (up to 320 MHz). The channel status of each subchannel within a large-size MRU allocated to an STA may be different. In this case, the STA can indicate information about subchannels with good channel conditions when receiving a signal, and the AP can improve overall transmission efficiency by allocating the optimal subchannel or RU to the STA and applying high MCS and high Nss to transmit the signal. This specification proposes a method of transmitting a signal by allocating a unified RU or multiple RUs within the BW by considering the optimal subchannel or RU for the STA when transmitting a signal to a non-AP STA/AP.

Considering backward compatibility, an 802.11be MU-PPDU for transmitting signals to multiple STAs may include L-STF, L-LTF, L-SIG, RL-SIG, U-SIG, EHT-SIG, EHT-STF, EHT-LTF, and Data.

The U-SIG may include version-independent and version-dependent fields.

The version-independent field may include a 3-bit version identifier indicating the 802.11be and later Wi-Fi versions, a 1-bit DL/UL field, BSS color, TXOP duration, etc. The version-dependent field may include information such as the PPDU format type, bandwidth, and MCS, etc.

The U-SIG is a jointly encoded two-symbol U-SIG, consisting of 52 data tones and 4 pilot tones every 20 MHz. Furthermore, the U-SIG is modulated in the same manner as the HE-SIG-A of 802.11ax (i.e., modulated at a BPSK ½ code rate).

EHT-SIG may be divided into common and user-specific fields and encoded with a variable MCS. The common field may indicate information for the spatial stream and RU being used, while the user-specific field may indicate information ID, MCS, and coding information used for a specific user or STA.

Furthermore, EHT-SIG may be composed of different information in 80 MHz units, and within 80 MHz, it consists of two EHT-SIG content channels (EHT-SIG CC1 and EHT-SIG CC2).

### 1. Procedure for Selecting the Best Subchannel (Optimal Channel) or RU in a Non-AP STA in a Wireless LAN System

In UHR or next-generation wireless LAN systems, measurements are made on the best subchannel or RU from the STA perspective in order to transmit signals using the optimal subchannel or RU for each STA,
In this case, the size of the subchannel or RU being measured has a minimum size of 242-tone RU/20 MHz. That is, the size of the subchannel or RU for measuring the best subchannel or RU size can be configured as 242/484/99-tone RU or 20/40/80 MHz.
Measurement of the best subchannel or RU for signal transmission can be performed at the request of the AP or during channel sounding.

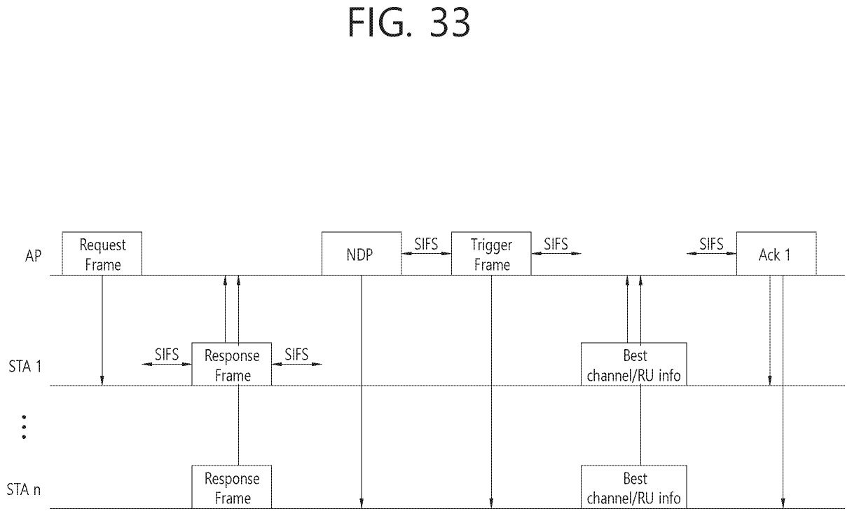

When performed by an AP request, it can be performed by a procedure such as that in FIG. 33, for example.

FIG. 33 illustrates a procedure for an STA to select an optimal subchannel or RU.

As shown in the example in FIG. 33, in order to measure the best subchannel or RU for STA(s), the AP transmits a request frame for measuring this to the STA(s).

In this case, the request frame is composed of a Best channel measurement request subfield, a BW subfield, a Puncturing information or disallowed subchannel information subfield, and a User info subfield.

The best channel measurement request subfield can consist of 1 bit and instructs the STA to perform best channel measurement.

The BW subfield contains information about the BW over which the Null Data Packet (NDP) performing channel measurement is transmitted, and is set to 20/40/80/160/320 MHz.

The Puncturing Information or Disallowed Subchannel Information subfield provides information for available channels within the Basic Service Set (BSS)

The Best Channel Measurement Information subfield consists of the Subchannel Resolution Size and the Subchannel Bitmap, as follows:

The above Subchannel resolution size can be configured as 242/484-tone RU or 20/40 MHz.

For example, the Best channel measurement information subfield may be configured as a 9-bit table (1-bit resolution, 8-bit best channel indication).

The 8-bit best channel indication is indicated for 80/160/320 MHz and is configured as follows for each BW.

1) 80 MHz-4 bits (indicated in 242-tone RU units, the Least Significant Bit (LSB) or last 4 bits are reserved)

2) 160 MHz-8 bits (indicated in 242-tone RU units) or 484-tone RU units may also be indicated.

3) 320 MHz-8 bits (indicated in 484-tone RU units/996-tone RU units). If 996-tone RU is used as the resolution, the LSB or last 4 bits are reserved.

In another embodiment, the Best channel measurement information subfield may be fixed to a specific RU size for each BW. In this embodiment, the Best channel measurement information subfield does not require information indicating the resolution size, and its value is determined according to the BW.

For example, the resolution size is fixed to 242-tone RU at 80 MHz, 484-tone RU at 160 MHz, and 996-tone RU at 320 MHz. In other words, since it is fixed to a specific size according to BW, separate signaling is not required. The Best channel measurement information subfield includes a Channel bitmap, and the Channel bitmap consists of 4 bits, and each bit represents a subchannel or RU corresponding to the resolution size.

An STA (or non-AP STA) that receives a request frame transmitted by an AP receives the request frame and, after SIFS, transmits a response frame using the allocated RU. In this case, the response frame transmitted by the STA is composed of AID12 and a status code. The status code indicates success or denial in response to the received request.

The response frame can be either a CTS or CTS-to-self frame.

Unlike the above, the response frame for the request can be omitted in the procedure of FIG. 33.

Upon receiving a response frame from an STA(s), the AP transmits an NDP using the BW indicated in the request frame.

The STA(s) receiving the NDP from the AP perform measurements on subchannels or RUs using the channel measurement information included in the request information and select the best subchannel or RU.

The AP transmits a Trigger frame to the STA, requesting information for the best subchannel or RU selected by the STA based on the NDP reception.

Upon receiving the request for best subchannel or RU information from the AP, the STA uses its allocated RU to transmit information about the selected best subchannel or RU to the AP.

### 2. Method for Indicating Non-Continuous RU Combinations to Non-AP STAs

This embodiment describes non-continuous MRUs allocated for data transmission in a wireless LAN system.

As in the above-described embodiment, the AP can receive preferred channel or optimal channel information from the non-AP STA and consider the information and channel conditions when transmitting a signal. Therefore, if the SNR for a specific RU size within the MRU defined by the channel condition or interference is very poor from the non-AP STA side, making it difficult to use the existing defined MRU or reducing transmission efficiency, a signal can be transmitted by allocating multiple RUs spaced apart from each other within the BW, and RUs with a size of 242-tones or more can be allocated to one STA as follows.

Signal transmission through multiple RU allocation can be applied to a BW of 80 MHz or more based on information about the subchannel or large size RU (information about the best subchannel or RU in the previous embodiment).

The multiple RU allocation transmission is used for Multi-User (MU) transmission or OFDMA transmission.

The AP can transmit and receive signals by applying different transmission parameters to each RU based on the channel status of each allocated RU. These different transmission parameters can include the Modulation and Coding Scheme (MCS), Number of Spatial Streams (NSS), and coding.

Considering the resolution size for the above optimal channel measurement, the RU size used for transmission using multiple RUs at 80/160/320 MHz can be defined as follows.

TABLE 10

| BW | 80 MHz | 160 MHz | 320 MHz |
|---|---|---|---|
| Allocated RU size | 242 | 484 | 996 |

Considering the allocated RU sizes in Table 10 above, the RU allocation for multiple RU transmissions in a bandwidth of 80 MHz or more can be configured as follows. The proposed RU allocation combinations below are not included in the MRU combinations defined in 802.11be and are considered non-contiguous.
1) 80 MHz-Allocation is based on 242-tone RUs, and the allocated RUs are not contiguous.
   242-tone RU+242-tone RU (1x1x/1xx1/x1x1)
   The part marked as 1 above represents 242-tone RUs allocated within 80 MHz, and the part marked as x represents unallocated 242-tone RUs.
2) 160 MHz-allocated based on 484-tone RU.
   484-tone RU+484-tone RU (2x2x/2xx2/x2x2)
   The part marked as 2 above represents the 484-tone RU allocated within 160 MHz, and the part marked as x represents the unallocated 484-tone RU.
3) 320 MHz-allocated based on 996-tone RU.
   996-tone RU+996-tone RU (3x3x/3xx3/x3x3)
   The part marked with 3 above represents the 996-tone RUs allocated within 320 MHz, and the part marked with x represents the unallocated 996-tone RUs.

Two methods can be considered to indicate to non-AP STAs the discontinuously allocated RU combinations described above. In each case, information about multiple allocated RUs is transmitted as follows:

### 1) Method of Allocating Multiple User Fields to a Single STA Using a Previously Defined RU Allocation

A. As before, the RU allocation subfield is individually indicated for each allocated Multiple RU, and in this case, the User field corresponding to each RU allocation is included.

i. In this case, a user field is configured for each non-continuous RU within the MRU.
The user field assigned to each RU has the same Association Identifier (AID), and can be configured by setting different MCS, NSS, and coding.
The user field can be configured by reusing previously defined user fields and can include the following information:

### A. Number of Allocated RUs (Subfield)

i. In the First user field, the information may be set to “total number of allocated RUs −1.” Starting with the user fields following the First user field, the information may be set to a number counted by −1. In the Last user field, the information may be set to 0 to indicate the last field.

ii. The subfield for the “Number of Allocated RUs” may consist of ½ bits.

### B. Remaining User Field

i. For example, the Remaining User field indicates the number of allocated remaining user fields excluding the current user field and may consist of ⅔ bits.

ii. The Remaining User field is set to a number that sequentially counts −1 for each user field. If this information is set to 0, it indicates that there are no more user fields, and the STA no longer performs user field decoding.

iii. The Remaining User field may be set to ½ bit.

### C. Indicator for Whether it is the Last User Field

i. The indicator for whether it is the Last user field is an indicator for whether the allocated user field is the last field and may consist of 1 bit. If the indicator is set to 0, it indicates that it is not the last user field. In this case, the STA performs decoding of the user field until it finds a user field having an AID12 set identical to its own AID12. If the indicator is set to 1, it indicates that it is the last allocated user field, meaning that there are no more allocated user fields, and the STA may no longer perform decoding on the user field.

### D. Indicator for More User Fields

i. The indicator for the “More User Field” indicates whether there are additional user fields allocated after the corresponding user field.

ii. The indicator for the “More User Field” consists of 1 bit. If the indicator is set to 1, this indicates the presence of additional allocated user fields. The STA performs decoding until it finds a user field with an AID12 identical to its own AID12. In this case, the STA continues to decode user fields until it finds a user field with the same AID and the indicator set to 0. If the indicator is set to 0, this indicates that there are no more allocated user fields. In this case, the STA no longer performs decoding of user fields.

3. When transmitting and receiving signals using non-continuous multiple RUs, UHR-SIG or next-wifi SIG can be configured to include one of the subfields suggested in A, B, C, and D above.

ii. For example, when transmitting and receiving signals by allocating multiple RUs at 80 MHz, if the allocated 242+242-tone RUs are the first and third 20 MHz within 80 MHz, each 242-tone RU is indicated through RU allocation subfield 1 and RU allocation subfield 3 in CC1 and CC2 (content channel 1 and content channel 2) of UHR-SIG, respectively. At this time, two user fields for RU allocation subfield 1 and RU allocation subfield 3 are included in UHR-SIG.

iii. In this case, the RU allocation subfield for the previously defined 242-tone RU can be used, eliminating the need to define a new RU allocation subfield.

2) As another example, a new RU allocation can be defined for the non-continuous multiple RUs defined above, and this can be used to indicate multiple RU allocations allocated to non-AP STAs.

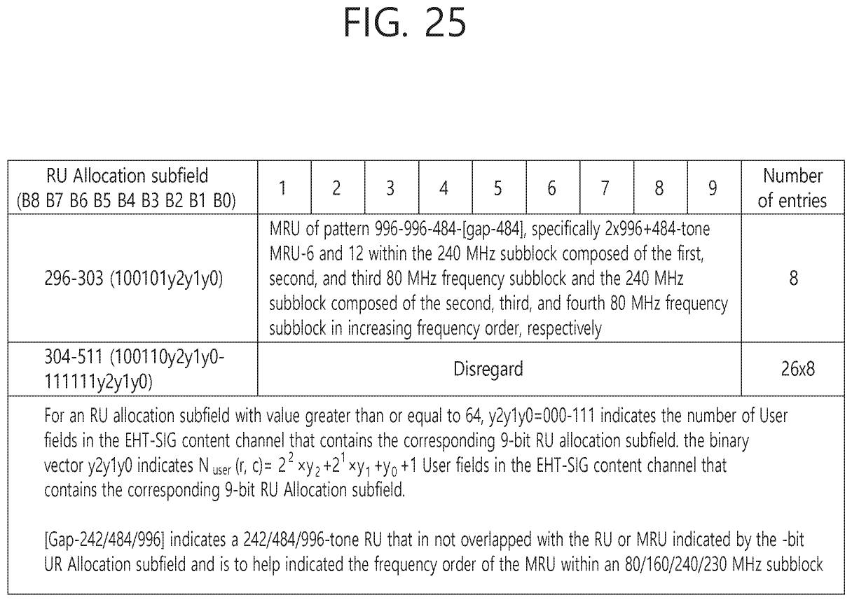

A. The indicator for the newly defined non-continuous multiple RUs is defined using the reserved value (or Disregard bits) of the RU allocation subfield (see FIG. 25).

i. As an example, using reserved values, the RU allocation subfield can be defined as follows:

TABLE 11

| RU Allocation | | | | | | | | | | |
|---|---|---|---|---|---|---|---|---|---|---|
| subfield (B8 B7 B6 | | | | | | | | | | Number |
| B5 B4 B3 B2 B1 B0) | 1 | 2 | 3 | 4 | 5 | 6 | 7 | 8 | 9 | of entries |
| . . . | . . . | | | | | | | | | . . . |
| 304 (100110000) | Block [1st_242, 3rd_242] within the first, second, third, | | | | | | | | | 1 |
| | and fourth 80 MHz frequency subblock in increasing | | | | | | | | | |
| | frequency order, respectively | | | | | | | | | |
| 305 (100110001) | Block[1st_242, 4th_242] within the first, second, third, | | | | | | | | | 1 |
| | and fourth 80 MHz frequency subblock in increasing | | | | | | | | | |
| | frequency order, respectively | | | | | | | | | |
| 306 (100110010) | Block[2nd_242, 4th_242] within the first, second, third, | | | | | | | | | 1 |
| | and fourth 80 MHz frequency subblock in increasing | | | | | | | | | |
| | frequency order, respectively | | | | | | | | | |
| 307 (100110011) | Block[1st_484, 3rd_484] within the first and second | | | | | | | | | 1 |
| | 160 MHz subblock in increasing frequency order, | | | | | | | | | |
| | respectively | | | | | | | | | |
| 308 (100110100) | Block[1st_484, 4th_484] within the first and second | | | | | | | | | 1 |
| | 160 MHz subblock in increasing frequency order, | | | | | | | | | |
| | respectively | | | | | | | | | |
| 309 (100110101) | Block[2nd_996, 4th_484] within the first and second | | | | | | | | | 1 |
| | 160 MHz subblock in increasing frequency order, | | | | | | | | | |
| | respectively | | | | | | | | | |
| 310 (100110110) | Block[1st_996, 3rd_996] within the 320 MHz | | | | | | | | | 1 |
| 311 (100110111) | Block[1st_996, 4th_996] within the 320 MHz | | | | | | | | | 1 |
| 312 (100111000) | Block[2nd_996, 4th_996] within the 320 MHz | | | | | | | | | 1 |
| 313-511 (100111001- | Disregard | | | | | | | | | |
| 111111y2y1y0) | | | | | | | | | | |

ii. The RU allocation subfield allocated for multiple RU allocation specified in Table 11 above is an example and may be defined using other reserved values.

The following signal transmission may be considered to transmit and receive signals by allocating non-continuous multiple RUs.

The following signaling can be used to indicate that the AP is transmitting signals using non-continuous multiple RUs during MU transmission:
For example, the AP indicates the use of non-continuous multiple RU allocation via the U-SIG. For example, the validate or disregards bits in U-SIG 1 or U-SIG 2 can be used, or one of the bits B20-B25 in U-SIG 1 or B2 or B8 in U-SIG 2 can be used.

As another example, it can be indicated using the reserved UL/DL subfield=0 and PPDU Type And Compression Mode value=3 among the UL/DL subfields and PPDU Type And Compression Mode field combinations included in the U-SIG.
In another case, it can be indicated using the contents of the common field of the UHR-SIG or Next wifi-SIG.

For example, the common field can be configured to include a bit indicating whether non-continuous multiple RUs are supported, and specifically, a “support or presence of non-continuous multiple RUs” subfield can be configured. The “support or presence of non-continuous multiple RUs” subfield consists of 1 bit. If the bit is set to 1, it indicates that non-continuous multiple RUs are supported, and if the bit is set to 0, it indicates that non-continuous multiple RUs are not supported.
User-specific content, rather than the common field, can also be used to indicate this.

For example, whether or not to transmit Multiple RUs can be indicated through the user field, and the User field can be configured as follows:

Based on the RU allocation for the Multiple RU allocation defined above, the User field can be configured as follows:
The user field of UHR-SIG or next wi-fi SIG has a unified format regardless of multiple RU transmission or conventional unified RU/MRU transmission. One User field corresponding to the RU allocation subfield can be configured to include different MCS and NSS information for each RU. That is, the User field can be configured as MCS per RU1, MCS per RU2, Nss per RU1, and Nss per RU2.

At this time, MCS is supported in the same way as before and can be set to 4 bits. Nss can be flexibly set up to a maximum of 8. For example, if Nss of RU1 is 2, Nss of RU2 can be set to 6.

In other cases, Nss can be flexibly set within the max value, with a maximum of 4 per block, such as MU-MIMO. In this case, information about the Nss can be composed of 2 bits (e.g., 00 01 10 11).

When allocating a unified RU in the User field configured as above, MCS1 (MCS per RU1) and NSS1 (Nss per RU1) in the user field are set to the same settings as in the previously defined RU, and at this time, MCS2 (MCS per RU2) and NSS2 (Nss per RU2) are reserved.

3) As another example, a method of newly defining the RU allocation subfield newly defined in 2) above (see Table 11) and using it to indicate multiple RU allocations allocated to non-AP STAs, but also configuring a user field for each non-continuous RU (or subchannel) within an MRU can be proposed. (Since a user field is configured for each RU, it is composed of multiple user fields.)

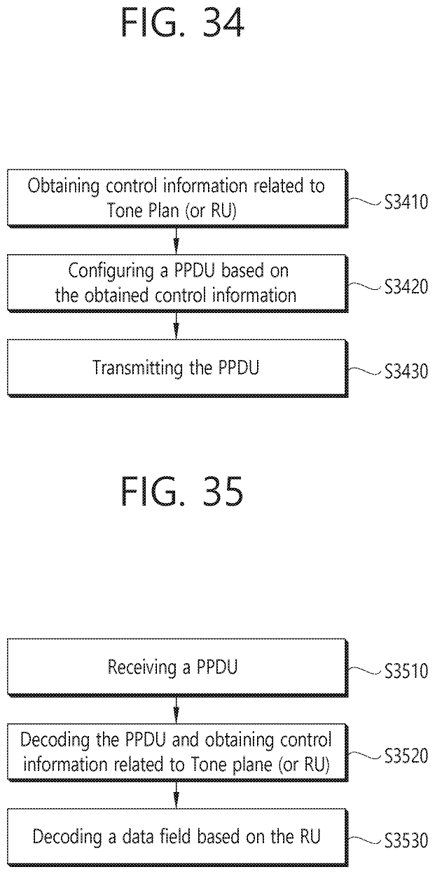

FIG. 34 is a flowchart illustrating the operation of a transmitting device according to the present embodiment.

The example of FIG. 34 may be performed by a transmitting device (AP and/or non-AP STA).

Some of each step (or detailed sub-step to be described later) of the example of FIG. 34 may be skipped/omitted.

Through step S3410, the transmitting device (transmitting STA) may obtain information about the above-described tone plan. As described above, the information about the tone plan includes the size and location of the RU, control information related to the RU, information about a frequency band including the RU, information about an STA receiving the RU, and the like.

Through step S3420, the transmitting device may construct/generate a PPDU based on the acquired control information. Configuring/generating the PPDU may include configuring/generating each field of the PPDU. That is, step S3420 includes configuring the EHT-SIG field including control information about the tone plan. That is, step S3420 includes configuring a field including control information (e.g., N bitmap) indicating the size/position of the RU; and/or configuring a field including an identifier of an STA receiving the RU (e.g., AID).

Also, step S3420 may include generating an STF/LTF sequence transmitted through a specific RU. The STF/LTF sequence may be generated based on a preset STF generation sequence/LTF generation sequence.

Also, step S3420 may include generating a data field (i.e., MPDU) transmitted through a specific RU.

The transmitting device may transmit the PPDU constructed through step S3420 to the receiving device based on step S3430.

While performing step S3430, the transmitting device may perform at least one of operations such as CSD, Spatial Mapping, IDFT/IFFT operation, and GI insertion.

A signal/field/sequence constructed according to the present specification may be transmitted in the form of FIG. 5.

FIG. 35 is a flowchart illustrating the operation of the receiving apparatus/device according to the present embodiment.

The aforementioned PPDU may be received according to the example of FIG. 35.

The example of FIG. 35 may be performed by a receiving apparatus/device (AP and/or non-AP STA).

Some of each step (or detailed sub-step to be described later) of the example of FIG. 35 may be skipped/omitted.

The receiving device (receiving STA) may receive all or part of the PPDU through step S3510. The received signal may be in the form of FIG. 5.

A sub-step of step S3510 may be determined based on step S3430 of FIG. 34. That is, in step S3510, an operation of restoring the result of the CSD, Spatial Mapping, IDFT/IFFT operation, and GI insertion operation applied in step S3430 may be performed.

In step S3520, the receiving device may perform decoding on all/part of the PPDU. Also, the receiving device may obtain control information related to a tone plan (i.e., RU) from the decoded PPDU.

More specifically, the receiving device may decode the L-SIG and EHT-SIG of the PPDU based on the legacy STF/LTF and obtain information included in the L-SIG and EHT SIG fields. Information on various tone plans (i.e., RUs) described in this specification may be included in the EHT-SIG, and the receiving STA may obtain information on the tone plan (i.e., RU) through the EHT-SIG.

In step S3530, the receiving device may decode the remaining part of the PPDU based on information about the tone plan (i.e., RU) acquired through step S3520. For example, the receiving STA may decode the STF/LTF field of the PPDU based on information about one plan (i.e., RU). In addition, the receiving STA may decode the data field of the PPDU based on information about the tone plan (i.e., RU) and obtain the MPDU included in the data field.

In addition, the receiving device may perform a processing operation of transferring the data decoded through step S3530 to a higher layer (e.g., MAC layer). In addition, when generation of a signal is instructed from the upper layer to the PHY layer in response to data transmitted to the upper layer, a subsequent operation may be performed.

Hereinafter, the above-described embodiment will be described with reference to FIG. 1 to FIG. 35.

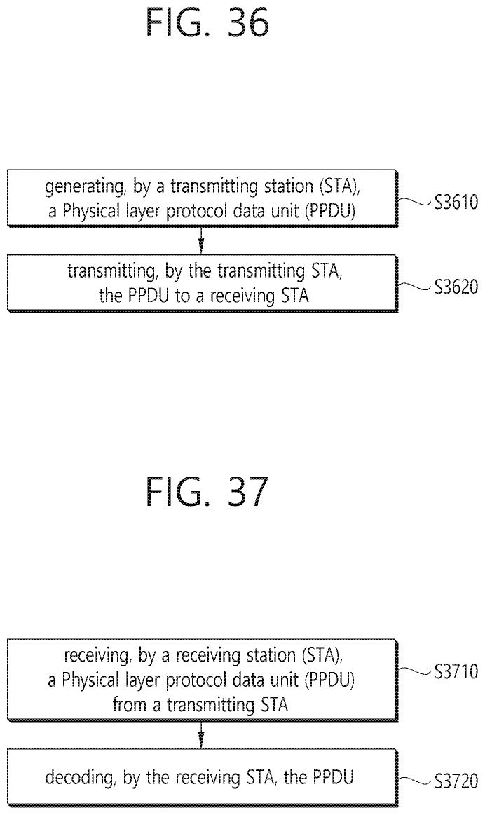

FIG. 36 is a flowchart illustrating a procedure for transmitting a PPDU according to the present embodiment.

The example of FIG. 36 may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

The example of FIG. 36 is performed at a transmitting STA, which may correspond to an access point (AP). The receiving STA of FIG. 36 may correspond to at least one STA (station).

This embodiment proposes a method for allocating an MRU composed of two non-continuous RUs and configuring a signal field for transmitting data by applying different transmission parameters, e.g., MCS and Nss, to each RU. In particular, the present embodiment proposes a method for allocating two non-continuous RUs within an MRU through a new RU allocation subfield in the signal field and configuring one unified user field for each of the two RUs to indicate the MCS and Nss applied to each RU.

In step S3610, a transmitting station (STA) generates a Physical layer protocol data unit (PPDU).

In step S3620, the transmitting STA transmits the PPDU to a receiving STA.

The PPDU includes first and second signal fields and a data field.

The first signal field includes information that the data field is transmitted through a Multiple Resource Unit (MRU) composed of a combination of non-continuous first and second Resource Units (RUs).

The second signal field includes a common field and a user-specific field. The common field includes RU allocation information for the combination of the non-continuous first and second RUs. The RU allocation information is newly defined information based on a value of a Disregard bit (or reserved bit) of the RU allocation subfield, and a detailed description will be provided later.

The user-specific field includes one user field integrated for the first and second RUs. The one user field may be configured to include different MCS and Nss information for each RU. For example, the one user field includes information on a first Modulation and Coding Scheme (MCS) applied to the first RU and information on a second MCS applied to the second RU.

Additionally, the one user field may further include information on a first Number of spatial streams (Nss) applied to the first RU and information on a second Nss applied to the second RU.

Based on a channel status of the first and second RUs, the first RU may be transmitted based on/by applying the first MCS and the first Nss, and the second RU may be transmitted based on/by applying the second MCS and the second Nss. A sum of the first and second Nss may not exceed 8.

In the past, there was a problem that the overall transmission efficiency and throughput were reduced when transmitting a signal by commonly applying transmission parameters to MRUs even when the channel condition of a specific channel within an MRU was poor due to OBSS, fading, etc. Therefore, this embodiment proposes a method of transmitting a signal by applying different transmission parameters to each RU by considering the channel status of an MRU composed of non-continuous RUs. That is, this embodiment proposes a method of configuring a newly defined RU allocation subfield to apply different MCS and Nss to each RU within the MRU and a single integrated user field for non-continuous RUs. That is, by transmitting a signal by applying transmission parameters suitable for the channel status to each RU within an MRU, there is an effect of improving the overall transmission efficiency and throughput compared to applying common (or unified) transmission parameters to the MRU.

Furthermore, this embodiment proposes a method for applying transmission parameters within an MRU composed of a combination of non-continuous RUs, rather than an MRU composed of a combination of RUs defined in 802.11be. This is because the channel status of continuous RUs are considered similar, and thus applying separate transmission parameters is not very beneficial. Non-continuous RUs can also receive Receiver (Rx) chains in parallel.

Based on a bandwidth of the PPDU being 80 MHz, the 80 MHz may include first to fourth 242-tone RUs or first and second 484-tone RUs in order from low to high frequency.

Based on the bandwidth of the PPDU being 160 MHz, the 160 MHz may include first to fourth 484-tone RUs in order from low to high frequency.

Based on the bandwidth of the PPDU being 320 MHz, the 320 MHz may include first to fourth 996-tone RUs in order from low to high frequency.

The RU allocation information may include information for a size and location of a resource for the first RU and a size and location of a resource for the second RU. Specifically, the RU allocation information may indicate information for the size and location of the resource for each RU based on a value of a Disregard bit (or reserved bit) of the existing RU allocation subfield. According to the present embodiment, there is no need to define additional signaling separately for resource allocation per RU within an MRU, thereby having the effect of not increasing signaling overhead.

The resource allocation per RU within the MRU according to/based on a value of the RU allocation information is as follows.

Based on the RU allocation information being set to 304, the MRU may be a 242+242-tone MRU within an 80 MHz frequency subblock, and the first RU may be related to the first 242-tone RU, and the second RU may be related to the third 242-tone RU.

Based on the RU allocation information being set to 305, the MRU may be a 242+242-tone MRU within an 80 MHz frequency subblock, and the first RU may be related to the first 242-tone RU, and the second RU may be related to the fourth 242-tone RU.

Based on the RU allocation information being set to 306, the MRU may be a 242+242-tone MRU within an 80 MHz frequency subblock, and the first RU may be related to the second 242-tone RU, and the second RU may be related to the fourth 242-tone RU.

Based on the RU allocation information being set to 307, the MRU may be a 484+484-tone MRU within a 160 MHz frequency subblock, and the first RU may be related to the first 484-tone RU, and the second RU may be related to the third 484-tone RU

Based on the RU allocation information being set to 308, the MRU may be a 484+484-tone MRU within a 160 MHz frequency subblock, and the first RU may be related to the first 484-tone RU, and the second RU may be related to the fourth 484-tone RU.

Based on the RU allocation information being set to 309, the MRU may be a 484+484-tone MRU within a 160 MHz frequency subblock, and the first RU may be related to the second 484-tone RU, and the second RU may be related to the fourth 484-tone RU.

Based on the RU allocation information being set to 310, the MRU may be a 996+996-tone MRU within a 160 MHz frequency subblock, and the first RU may be related to the first 996-tone RU, and the second RU may be related to the third 996-tone RU.

Based on the RU allocation information being set to 311, the MRU may be a 996+996-tone MRU within a 160 MHz frequency subblock, and the first RU may be related to the first 996-tone RU, and the second RU may be related to the fourth 996-tone RU.

Based on the RU allocation information being set to 312, the MRU may be a 996+996-tone MRU within a 160 MHz frequency subblock, and the first RU may be related to the second 996-tone RU, and the second RU may be related to the fourth 996-tone RU.

The first signal field may be a Universal-Signal (U-SIG), and the second signal field may be an Ultra High Reliability-Signal (UHR-SIG).

The one user field may be encoded together with the common field to form a common encoding block. The common encoding block may include U-SIG overflow, the RU allocation information, the first user field, a Cyclic Redundancy Check (CRC), and a Tail.

As another example, the common field includes RU allocation information for the first and second RUs. The RU allocation information may be configured separately for allocation information for the first RU and allocation information for the second RU, similar to the existing RU allocation subfield.

At this time, the user-specific field may be configured with different user fields for the first and second RUs. That is, the user-specific field includes a first user field for the first RU and a second user field for the second RU. The first user field includes information on a first MCS applied to the first RU. The second user field includes information on a second MCS applied to the second RU. The first user field may further include information on the first Nss applied to the first RU. The second user field may further include information on the second Nss applied to the second RU. Content or subfields excluding the MCS and Nss in the first and second user fields may be configured identically.

The first user field may be encoded together with the common field to form a common encoding block. The common encoding block may include a U-SIG overflow, the RU allocation information, the first user field, a Cyclic Redundancy Check (CRC), and a Tail. In the user-specific field, the second user field may be formed as a user encoding block. In this case, the user encoding block may include the second user field, a CRC, and a Tail.

The combination of the first and second non-continuous RUs within the MRU may be obtained by measuring the optimal subchannel or RU at the receiving STA. The measurement of the optimal subchannel or RU at the receiving STA may be performed at the request of the transmitting STA or during channel sounding.

Specifically, the transmitting STA may transmit a request frame to the receiving STA. The request frame may include a bit requesting the receiving STA to perform measurement for an optimal channel. The request frame may include information on a bandwidth through which a Null Data Packet (NDP) used to perform channel measurement is transmitted, information on available channels (punctured or disallowed channels) within the BSS, information on an optimal channel (resolution size of a subchannel and a bitmap for the subchannel), and information on receiving STAs performing channel measurement (AID and RU allocation information).

The transmitting STA may receive a response frame to the request frame from the receiving STA. The response frame may include its own AID information and a status code indicating whether the request frame was successful or denied.

The transmitting STA may transmit the NDP to the receiving STA through the bandwidth allocated by the request frame. The receiving STA, upon receiving the NDP, may perform the measurement based on information on the channel included in the request frame to select an optimal subchannel or RU.

The transmitting STA may transmit a trigger frame to the receiving STA to request information on the optimal subchannel or RU selected by the receiving STA based on the NDP. The receiving STA may transmit information on the optimal subchannel or RU to the transmitting STA through the RU allocated by the trigger frame.

Based on the information about the optimal subchannel or RU acquired through the preceding operation, the transmitting STA may configure a combination of non-continuous first and second RUs within the one MRU.

FIG. 37 is a flowchart illustrating a procedure for receiving a PPDU according to the present embodiment.

The example of FIG. 37 may be performed in a network environment that supports a next-generation wireless LAN system (Ultra High Reliability (UHR) wireless LAN system or next Wi-Fi). The next-generation wireless LAN system is an improved version of the 802.11be system and can satisfy backward compatibility with the 802.11be system.

The example of FIG. 37 is performed at a receiving STA, which may correspond to at least one station (STA). The transmitting STA of FIG. 37 may correspond to an access point (AP).

This embodiment proposes a method for allocating an MRU composed of two non-continuous RUs and configuring a signal field for transmitting data by applying different transmission parameters, e.g., MCS and Nss, to each RU. In particular, the present embodiment proposes a method for allocating two non-continuous RUs within an MRU through a new RU allocation subfield in the signal field and configuring one unified user field for each of the two RUs to indicate the MCS and Nss applied to each RU.

In step S3710, a receiving station (STA) receives a Physical layer protocol data unit (PPDU) from a transmitting STA.

In step S3720, the receiving STA decodes the PPDU.

The PPDU includes first and second signal fields and a data field.

The first signal field includes information that the data field is transmitted through a Multiple Resource Unit (MRU) composed of a combination of non-continuous first and second Resource Units (RUs).

The second signal field includes a common field and a user-specific field. The common field includes RU allocation information for the combination of the non-continuous first and second RUs. The RU allocation information is newly defined information based on a value of a Disregard bit (or reserved bit) of the RU allocation subfield, and a detailed description will be provided later.

The user-specific field includes one user field integrated for the first and second RUs. The one user field may be configured to include different MCS and Nss information for each RU. For example, the one user field includes information on a first Modulation and Coding Scheme (MCS) applied to the first RU and information on a second MCS applied to the second RU.

Additionally, the one user field may further include information on a first Number of spatial streams (Nss) applied to the first RU and information on a second Nss applied to the second RU.

Based on a channel status of the first and second RUs, the first RU may be transmitted based on/by applying the first MCS and the first Nss, and the second RU may be transmitted based on/by applying the second MCS and the second Nss. A sum of the first and second Nss may not exceed 8.

In the past, there was a problem that the overall transmission efficiency and throughput were reduced when transmitting a signal by commonly applying transmission parameters to MRUs even when the channel condition of a specific channel within an MRU was poor due to OBSS, fading, etc. Therefore, this embodiment proposes a method of transmitting a signal by applying different transmission parameters to each RU by considering the channel status of an MRU composed of non-continuous RUs. That is, this embodiment proposes a method of configuring a newly defined RU allocation subfield to apply different MCS and Nss to each RU within the MRU and a single integrated user field for non-continuous RUs. That is, by transmitting a signal by applying transmission parameters suitable for the channel status to each RU within an MRU, there is an effect of improving the overall transmission efficiency and throughput compared to applying common (or unified) transmission parameters to the MRU.

Furthermore, this embodiment proposes a method for applying transmission parameters within an MRU composed of a combination of non-continuous RUs, rather than an MRU composed of a combination of RUs defined in 802.11be. This is because the channel status of continuous RUs are considered similar, and thus applying separate transmission parameters is not very beneficial. Non-continuous RUs can also receive Receiver (Rx) chains in parallel.

Based on a bandwidth of the PPDU being 80 MHz, the 80 MHz may include first to fourth 242-tone RUs or first and second 484-tone RUs in order from low to high frequency.

Based on the bandwidth of the PPDU being 160 MHz, the 160 MHz may include first to fourth 484-tone RUs in order from low to high frequency.

Based on the bandwidth of the PPDU being 320 MHz, the 320 MHz may include first to fourth 996-tone RUs in order from low to high frequency.

The RU allocation information may include information for a size and location of a resource for the first RU and a size and location of a resource for the second RU. Specifically, the RU allocation information may indicate information for the size and location of the resource for each RU based on a value of a Disregard bit (or reserved bit) of the existing RU allocation subfield. According to the present embodiment, there is no need to define additional signaling separately for resource allocation per RU within an MRU, thereby having the effect of not increasing signaling overhead.

The resource allocation per RU within the MRU according to/based on a value of the RU allocation information is as follows.

Based on the RU allocation information being set to 304, the MRU may be a 242+242-tone MRU within an 80 MHz frequency subblock, and the first RU may be related to the first 242-tone RU, and the second RU may be related to the third 242-tone RU.

Based on the RU allocation information being set to 305, the MRU may be a 242+242-tone MRU within an 80 MHz frequency subblock, and the first RU may be related to the first 242-tone RU, and the second RU may be related to the fourth 242-tone RU.

Based on the RU allocation information being set to 306, the MRU may be a 242+242-tone MRU within an 80 MHz frequency subblock, and the first RU may be related to the second 242-tone RU, and the second RU may be related to the fourth 242-tone RU.

Based on the RU allocation information being set to 307, the MRU may be a 484+484-tone MRU within a 160 MHz frequency subblock, and the first RU may be related to the first 484-tone RU, and the second RU may be related to the third 484-tone RU

Based on the RU allocation information being set to 308, the MRU may be a 484+484-tone MRU within a 160 MHz frequency subblock, and the first RU may be related to the first 484-tone RU, and the second RU may be related to the fourth 484-tone RU.

Based on the RU allocation information being set to 309, the MRU may be a 484+484-tone MRU within a 160 MHz frequency subblock, and the first RU may be related to the second 484-tone RU, and the second RU may be related to the fourth 484-tone RU.

Based on the RU allocation information being set to 310, the MRU may be a 996+996-tone MRU within a 160 MHz frequency subblock, and the first RU may be related to the first 996-tone RU, and the second RU may be related to the third 996-tone RU.

Based on the RU allocation information being set to 311, the MRU may be a 996+996-tone MRU within a 160 MHz frequency subblock, and the first RU may be related to the first 996-tone RU, and the second RU may be related to the fourth 996-tone RU.

Based on the RU allocation information being set to 312, the MRU may be a 996+996-tone MRU within a 160 MHz frequency subblock, and the first RU may be related to the second 996-tone RU, and the second RU may be related to the fourth 996-tone RU,

The first signal field may be a Universal-Signal (U-SIG), and the second signal field may be an Ultra High Reliability-Signal (UHR-SIG).

The one user field may be encoded together with the common field to form a common encoding block. The common encoding block may include U-SIG overflow, the RU allocation information, the first user field, a Cyclic Redundancy Check (CRC), and a Tail.

As another example, the common field includes RU allocation information for the first and second RUs. The RU allocation information may be configured separately for allocation information for the first RU and allocation information for the second RU, similar to the existing RU allocation subfield.

At this time, the user-specific field may be configured with different user fields for the first and second RUs. That is, the user-specific field includes a first user field for the first RU and a second user field for the second RU. The first user field includes information on a first MCS applied to the first RU. The second user field includes information on a second MCS applied to the second RU. The first user field may further include information on the first Nss applied to the first RU. The second user field may further include information on the second Nss applied to the second RU. Content or subfields excluding the MCS and Nss in the first and second user fields may be configured identically.

The first user field may be encoded together with the common field to form a common encoding block. The common encoding block may include a U-SIG overflow, the RU allocation information, the first user field, a Cyclic Redundancy Check (CRC), and a Tail. In the user-specific field, the second user field may be formed as a user encoding block. In this case, the user encoding block may include the second user field, a CRC, and a Tail.

The combination of the first and second non-continuous RUs within the MRU may be obtained by measuring the optimal subchannel or RU at the receiving STA. The measurement of the optimal subchannel or RU at the receiving STA may be performed at the request of the transmitting STA or during channel sounding.

Specifically, the transmitting STA may transmit a request frame to the receiving STA. The request frame may include a bit requesting the receiving STA to perform measurement for an optimal channel. The request frame may include information on a bandwidth through which a Null Data Packet (NDP) used to perform channel measurement is transmitted, information on available channels (punctured or disallowed channels) within the BSS, information on an optimal channel (resolution size of a subchannel and a bitmap for the subchannel), and information on receiving STAs performing channel measurement (AID and RU allocation information).

The transmitting STA may receive a response frame to the request frame from the receiving STA. The response frame may include its own AID information and a status code indicating whether the request frame was successful or denied.

The transmitting STA may transmit the NDP to the receiving STA through the bandwidth allocated by the request frame. The receiving STA, upon receiving the NDP, may perform the measurement based on information on the channel included in the request frame to select an optimal subchannel or RU.

The transmitting STA may transmit a trigger frame to the receiving STA to request information on the optimal subchannel or RU selected by the receiving STA based on the NDP. The receiving STA may transmit information on the optimal subchannel or RU to the transmitting STA through the RU allocated by the trigger frame.

Based on the information about the optimal subchannel or RU acquired through the preceding operation, the transmitting STA may configure a combination of non-continuous first and second RUs within the one MRU.

### <Device Configuration>

The technical features of the present disclosure may be applied to various devices and methods. For example, the technical features of the present disclosure may be performed/supported through the device(s) of FIG. 1 and/or FIG. 14. For example, the technical features of the present disclosure may be applied to only part of FIG. 1 and/or FIG. 14. For example, the technical features of the present disclosure may be implemented based on the processing chip(s) 114 and 124 of FIG. 1, or implemented based on the processor(s) 111 and 121 and the memory(s) 112 and 122, or implemented based on the processor 610 and the memory 620 of FIG. 14. For example, the device according to the present disclosure receives a Physical layer protocol data unit (PPDU) from a transmitting station (STA); and decodes the PPDU.

The technical features of the present disclosure may be implemented based on a computer readable medium (CRM). For example, a CRM according to the present disclosure is at least one computer readable medium including instructions designed to be executed by at least one processor.

The CRM may store instructions that perform operations including receiving a Physical layer protocol data unit (PPDU) from a transmitting station (STA); and decoding the PPDU. At least one processor may execute the instructions stored in the CRM according to the present disclosure. At least one processor related to the CRM of the present disclosure may be the processor 111, 121 of FIG. 1, the processing chip 114, 124 of FIG. 1, or the processor 610 of FIG. 14. Meanwhile, the CRM of the present disclosure may be the memory 112, 122 of FIG. 1, the memory 620 of FIG. 14, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless local area network (WLAN) system, the method comprising:
receiving, by a receiving station (STA), a Physical layer protocol data unit (PPDU) from a transmitting STA; and
decoding, by the receiving STA, the PPDU,
wherein the PPDU includes first and second signal fields and a data field,
wherein first signal field includes information that the data field is transmitted through a Multiple Resource Unit (MRU) composed of a combination of non-continuous first and second Resource Units (RUs),
wherein the second signal field includes a common field and a user-specific field,
wherein the common field includes RU allocation information for the combination of the non-continuous first and second RUs,
wherein the user-specific field includes one user field integrated for the first and second RUs, and
wherein the one user field includes information on a first Modulation and Coding Scheme (MCS) applied to the first RU and information on a second MCS applied to the second RU.

2. The method of claim 1, wherein the RU allocation information includes information for a size and location of a resource for the first RU and a size and location of a resource for the second RU,
wherein based on a bandwidth of the PPDU being 80 MHz, the 80 MHz includes first to fourth 242-tone RUs in order from low to high frequency,
wherein based on the bandwidth of the PPDU being 160 MHz, the 160 MHz includes first to fourth 484-tone RUs in order from low to high frequency, and
wherein based on the bandwidth of the PPDU being 320 MHz, the 320 MHz includes first to fourth 996-tone RUs in order from low to high frequency.

3. The method of claim 2, wherein based on the RU allocation information being set to 304,
the MRU is a 242+242-tone MRU within an 80 MHz frequency subblock, and
the first RU is related to the first 242-tone RU, and the second RU is related to the third 242-tone RU.

4. The method of claim 2, wherein based on the RU allocation information being set to 305,
the MRU is a 242+242-tone MRU within an 80 MHz frequency subblock, and
the first RU is related to the first 242-tone RU, and the second RU is related to the fourth 242-tone RU.

5. The method of claim 2, wherein based on the RU allocation information being set to 306,
the MRU is a 242+242-tone MRU within an 80 MHz frequency subblock, and
the first RU is related to the second 242-tone RU, and the second RU is related to the fourth 242-tone RU.

6. The method of claim 2, wherein based on the RU allocation information being set to 307,
the MRU is a 484+484-tone MRU within a 160 MHz frequency subblock, and
the first RU is related to the first 484-tone RU, and the second RU is related to the third 484-tone RU.

7. The method of claim 2, wherein based on the RU allocation information being set to 308,
the MRU is a 484+484-tone MRU within a 160 MHz frequency subblock, and
the first RU is related to the first 484-tone RU, and the second RU is related to the fourth 484-tone RU.

8. The method of claim 2, wherein based on the RU allocation information being set to 309,
the MRU is a 484+484-tone MRU within a 160 MHz frequency subblock, and
the first RU is related to the second 484-tone RU, and the second RU is related to the fourth 484-tone RU.

9. The method of claim 2, wherein based on the RU allocation information being set to 310,
the MRU is a 996+996-tone MRU within a 160 MHz frequency subblock, and
the first RU is related to the first 996-tone RU, and the second RU is related to the third 996-tone RU.

10. The method of claim 2, wherein based on the RU allocation information being set to 311,
the MRU is a 996+996-tone MRU within a 160 MHz frequency subblock, and
the first RU is related to the first 996-tone RU, and the second RU is related to the fourth 996-tone RU.

11. The method of claim 2, wherein based on the RU allocation information being set to 312,
the MRU is a 996+996-tone MRU within a 160 MHz frequency subblock, and
the first RU is related to the second 996-tone RU, and the second RU is related to the fourth 996-tone RU.

12. The method of claim 1, wherein the one user field further includes information on a first Number of spatial streams (Nss) applied to the first RU and information on a second Nss applied to the second RU.

13. The method of claim 12, wherein based on a channel status of the first and second RUs, the first RU is transmitted based on the first MCS and the first Nss, and the second RU is transmitted based on the second MCS and the second Nss, and
wherein a sum of the first and second Nss does not exceed 8.

14. A receiving station (STA) in a wireless local area network (WLAN) system, the receiving STA comprising:
a memory;
a transceiver; and
a processor being operatively connected to the memory and the transceiver,
wherein the processor is configured to:
receive a Physical layer protocol data unit (PPDU) from a transmitting STA; and
decode the PPDU,
wherein the PPDU includes first and second signal fields and a data field,
wherein first signal field includes information that the data field is transmitted through a Multiple Resource Unit (MRU) composed of a combination of non-continuous first and second Resource Units (RUs),
wherein the second signal field includes a common field and a user-specific field,
wherein the common field includes RU allocation information for the combination of the non-continuous first and second RUs,
wherein the user-specific field includes one user field integrated for the first and second RUs, and
wherein the one user field includes information on a first Modulation and Coding Scheme (MCS) applied to the first RU and information on a second MCS applied to the second RU.

15. A method in a wireless local area network (WLAN) system, the method comprising:
generating, by a transmitting station (STA), a Physical layer protocol data unit (PPDU); and
transmitting, by the transmitting STA, the PPDU to a receiving STA,
wherein the PPDU includes first and second signal fields and a data field,
wherein first signal field includes information that the data field is transmitted through a Multiple Resource Unit (MRU) composed of a combination of non-continuous first and second Resource Units (RUs),
wherein the second signal field includes a common field and a user-specific field,
wherein the common field includes RU allocation information for the combination of the non-continuous first and second RUs,
wherein the user-specific field includes one user field integrated for the first and second RUs, and
wherein the one user field includes information on a first Modulation and Coding Scheme (MCS) applied to the first RU and information on a second MCS applied to the second RU.

16-20. (canceled)
